(19) United States
(12) Patent Application Publication
(10) Pub. No.: US 2025/0141872 A1
(43) Pub. Date: May 1, 2025

(54) METHODS, SYSTEMS AND APPARATUSES FOR SHARING VIDEO DATA ACROSS TENANTS OF A MULTI-TENANT SECURITY SYSTEM

(71) Applicant: GENETEC INC., Saint-Laurent (CA)

(72) Inventors: Christian Hamel, Deux-Montagnes (CA); Jeremy El Bez, Cote St-Luc (CA); Erick Ceresato, Montreal (CA)

(73) Assignee: GENETEC INC., Saint-Laurent (CA)

(21) Appl. No.: 18/637,018

(22) Filed: Apr. 16, 2024

Related U.S. Application Data
(60) Provisional application No. 63/546,580, filed on Oct. 31, 2023.

(51) Int. Cl. H04L 9/40

(52) U.S. Cl. CPC H04L 63/101

(57) ABSTRACT

Methods, systems and apparatuses for sharing video data across tenants of a multi-tenant security system. The methods may include maintaining a first tenant account of a security server and a second tenant account of the security server. The first tenant account is unrelated to the second tenant account. The second tenant account is configured to include partner account privileges for the first tenant account. A request from the second tenant account to access a resource associated with video data included in a resource registry of the first tenant account is accessed. The resource registry is made accessible to the second tenant account based on the partner account privileges. The request may be approved or denied. The video data is stored in a tenant database in association with the second tenant account based on the request being approved. The request may be processed by an image processing device.

### CROSS-REFERENCE TO RELATED APPLICATIONS

This application claims the benefit of U.S. Provisional Patent Application Ser. No. 63/546,580, filed on Oct. 31, 2023, hereby incorporated by reference herein.

### TECHNICAL FIELD

The present application generally relates to video data, more specifically to methods, systems and apparatuses sharing video data across tenants of a multi-tenant security system.

### BACKGROUND

During the course of an investigation, an investigator of an organization may require access to video data collected by devices such as IP cameras, mobile phones, body camera belonging to another unrelated organization. This video data may constitute digital evidence in the investigation.

In order to access this video data, the investigator may be required to submit a request to the unrelated organization to access to the video data. A typical request process begins with submitting a request (e.g., (by email download, physical, by hand) to the unrelated organization. The unrelated organization receiving the request must then take several steps to process the request including: identifying the video data corresponding to the request by searching a video database in which video data is stored, making a copy of the video data for the requestor for physical delivery and pickup (e.g., burn to a disc or save to a USB or external hard drive). Additionally, given that the video data may constitute digital evidence, proof of chain of custody must be established and maintained in order to preserve the integrity of the video data as evidence.

In some cases, this process is slow and cumbersome as it requires several steps to be taken between the time of request and the time of generating the copy of video data. Additionally, the process requires manual intervention (e.g., burn to a disc or saving to portable storage device like a USB key or external hard drive) which may further make the process slow and cumbersome.

Additionally, this process may lead to security concerns. Digital evidence can easily be copied, transferred, modified, deleted, tainted by new data and as such is vulnerable to a compromised chain of custody. If the chain of custody of the evidence is compromised, evidence may be rendered inadmissible.

In view of the foregoing, an improvement to the process of sharing video data from one entity to an unrelated entity may be desirable.

### SUMMARY

The present disclosure describes video data sharing methods in a multi-tenant security system which enable a first entity to share video data with a second entity, the first entity being unrelated to the second entity.

In accordance with a first aspect, there is provided a method for sharing video data across tenants of a multi-tenant security system, the method comprising: maintaining a first tenant account of the security server and a second tenant account of the security server, the first tenant account being unrelated to the second tenant account, the second tenant account being configured to include partner account privileges for the first tenant account; accessing a request from the second tenant account to access a resource included in a resource registry of the first tenant account, the resource registry being accessible to the second tenant account based on the partner account privileges, the resource being associated with video data; and automatically storing the video data associated with the resource in a tenant database in association with the second tenant account based on the request being approved.

In accordance with any of the preceding aspect, the resource registry being accessible to the second tenant account comprises making accessible a list of resources to the second tenant account.

In accordance with any of the preceding aspects, the resource registry being accessible to the second tenant account comprises making accessible a digital map graphically identifying locations of resources in a geographical area.

In accordance with any of the preceding aspects, the resource registry indicates a location of a resource.

In accordance with any of the preceding aspects, a resource in the resource registry comprises a vehicle camera.

In accordance with any of the preceding aspects, the vehicle camera is identified by a transit identifier.

In accordance with any of the preceding aspects, the tenant database is a plurality of tenant databases.

In accordance with any of the preceding aspects, the video data associated with the resource is inaccessible to the second tenant account until approval of the request.

In accordance with any of the preceding aspects, wherein the method further comprises processing the request at an interface of a computing apparatus of the system configured for processing the request, wherein processing comprises approving or denying the requests.

In accordance with any of the preceding aspects, the request is a first request for access to a first resource and the request further comprises a second request for access to a second resource, wherein the method further comprises: precluding the storing of the video data associated with the second resource in the tenant database in association with the second tenant account based on the second request being denied.

In accordance with any of the preceding aspects, the second tenant account retains partner account privileges for the first tenant account further to the request being denied.

In accordance with any of the preceding aspects, the request is approved based on approval criteria associated with the first tenant account.

In accordance with any of the preceding aspects, the approval criteria include receiving approval from one or more user accounts associated with the first tenant account, the one or more user accounts being authorized to approve the request.

In accordance with any of the preceding aspects, the method further comprises determining that the video data associated with the resource is not available for storing at the time of approval of the request, and automatically storing the video data associated with the resource in the tenant database in association with the second tenant account upon determining that it is available for storing.

In accordance with any of the preceding aspects, the method further comprises storing audit trail data associated with the video data.

In accordance with any of the preceding aspects, the audit trail data comprises audit trail data related to the first user account and audit trail data related to the second user account.

In accordance with any of the preceding aspects, the partner account privileges are bidirectional account privileges.

In accordance with any of the preceding aspects, the partner account privileges are unidirectional account privileges.

In accordance with a second example aspect, there is provided a security server, comprising: a processor; an interface; a memory operatively coupled to the processor and comprising computer-readable instructions executable by the processor; wherein execution of the computer-readable instructions by the processor causes the security server to carry out a method that comprises: maintaining a first tenant account of the security server and a second tenant account of the security server, the first tenant account being unrelated to the second tenant account, the second tenant account being configured to include partner account privileges for the first tenant account; accessing a request from the second tenant account to access a resource included in a resource registry of the first tenant account, the resource registry being accessible to the second tenant account based on the partner account privileges, the resource being associated with video data; and automatically storing the video data associated with the resource in a tenant database in association with the second tenant account based on the request being approved.

In accordance with any of the preceding aspect, the resource registry being accessible to the second tenant account comprises making accessible a list of resources to the second tenant account.

In accordance with any of the preceding aspects, the resource registry being accessible to the second tenant account comprises making accessible a digital map graphically identifying locations of resources in a geographical area.

In accordance with any of the preceding aspects, the resource registry indicates a location of a resource.

In accordance with any of the preceding aspects, a resource in the resource registry comprises a vehicle camera.

In accordance with any of the preceding aspects, the vehicle camera is identified by a transit identifier.

In accordance with any of the preceding aspects, the tenant database is a plurality of tenant databases.

In accordance with any of the preceding aspects, the video data associated with the resource is inaccessible to the second tenant account until approval of the request.

In accordance with any of the preceding aspects, wherein the method further comprises processing the request at an interface of a computing apparatus of the system configured for processing the request, wherein processing comprises approving or denying the request.

In accordance with any of the preceding aspects, the request is a first request for access to a first resource and the request further comprises a second request for access to a second resource, wherein the method further comprises: precluding the storing of the video data associated with the second resource in the tenant database in association with the second tenant account based on the second request being denied.

In accordance with any of the preceding aspects, the second tenant account retains partner account privileges for the first tenant account further to the request being denied.

In accordance with any of the preceding aspects, the request is a first request for access to a first resource and the request further comprises a second request for access to a second resource, wherein the method further comprises: precluding the storing of the video data associated with the second resource in the tenant database in association with the second tenant account based on the second request being denied.

In accordance with any of the preceding aspects, the request is approved based on approval criteria associated with the first tenant account.

In accordance with any of the preceding aspects, the approval criteria include receiving approval from one or more user accounts associated with the first tenant account, the one or more user accounts being authorized to approve the request.

In accordance with any of the preceding aspects, the method further comprises determining that the video data associated with the resource is not available for storing at the time of approval of the request, and automatically storing the video data associated with the resource in the tenant database in association with the second tenant account upon determining that it is available for storing.

In accordance with any of the preceding aspects, the method further comprises storing audit trail data associated with the video data.

In accordance with any of the preceding aspects, the audit trail data comprises audit trail data related to the first user account and audit trail data related to the second user account.

In accordance with any of the preceding aspects, the partner account privileges are bidirectional account privileges.

In accordance with any of the preceding aspects, the partner account privileges are unidirectional account privileges.

In accordance with a third example aspect, there is provided a non-transitory computer-readable medium comprising computer-readable instructions which, when executed by a processor of a security server, cause the security server to carry out a method that comprises: maintaining a first tenant account of the security server and a second tenant account of the security server, the first tenant account being unrelated to the second tenant account, the second tenant account being configured to include partner account privileges for the first tenant account; accessing a request from the second tenant account to access a resource included in a resource registry of the first tenant account, the resource registry being accessible to the second tenant account based on the partner account privileges, the resource being associated with video data; and automatically storing the video data associated with the resource in a tenant database in association with the second tenant account based on the request being approved.

In accordance with any of the preceding aspect, the resource registry being accessible to the second tenant account comprises making accessible a list of resources to the second tenant account.

In accordance with any of the preceding aspects, the resource registry being accessible to the second tenant account comprises making accessible a digital map graphically identifying locations of resources in a geographical area.

In accordance with any of the preceding aspects, the resource registry indicates a location of a resource.

In accordance with any of the preceding aspects, a resource in the resource registry comprises a vehicle camera.

In accordance with any of the preceding aspects, the vehicle camera is identified by a transit identifier.

In accordance with any of the preceding aspects, the tenant database is a plurality of tenant databases.

In accordance with any of the preceding aspects, the video data associated with the resource is inaccessible to the second tenant account until approval of the request.

In accordance with any of the preceding aspects, wherein the method further comprises processing the request at an interface of a computing apparatus of the system configured for processing the request, wherein processing comprises approving or denying the request.

In accordance with any of the preceding aspects, the request is a first request for access to a first resource and the request further comprises a second request for access to a second resource, wherein the method further comprises: precluding the storing of the video data associated with the second resource in the tenant database in association with the second tenant account based on the second request being denied.

In accordance with any of the preceding aspects, the second tenant account retains partner account privileges for the first tenant account further to the request being denied.

In accordance with any of the preceding aspects, the request is a first request for access to a first resource and the request further comprises a second request for access to a second resource, wherein the method further comprises: precluding the storing of the video data associated with the second resource in the tenant database in association with the second tenant account based on the second request being denied.

In accordance with any of the preceding aspects, the request is approved based on approval criteria associated with the first tenant account.

In accordance with any of the preceding aspects, the approval criteria include receiving approval from one or more user accounts associated with the first tenant account, the one or more user accounts being authorized to approve the request.

In accordance with any of the preceding aspects, the method further comprises determining that the video data associated with the resource is not available for storing at the time of approval of the request, and automatically storing the video data associated with the resource in the tenant database in association with the second tenant account upon determining that it is available for storing.

In accordance with any of the preceding aspects, the method further comprises storing audit trail data associated with the video data.

In accordance with any of the preceding aspects, the audit trail data comprises audit trail data related to the first user account and audit trail data related to the second user account.

In accordance with any of the preceding aspects, the partner account privileges are bidirectional account privileges.

In accordance with any of the preceding aspects, the partner account privileges are unidirectional account privileges.

In accordance with a fourth example aspect, there is provided a method for execution by an image processing device, the method comprising: generating video data to be stored in association with a first tenant account of a security server; accessing a request from a second tenant account of the security server to access the video data, the second tenant account being unrelated to the first tenant account; determining that the second tenant account is configured to include partner account privileges for the first tenant account, the video data being requestable based on the second tenant account having access to a resource registry of the first tenant account based on the partner account privileges; determining if the request is approved; and automatically transferring the video data to the security server for storage of the video data in a tenant database in association with the second tenant account based on the request being approved.

In accordance with any of the preceding aspects, wherein said automatically transferring comprises incrementally transferring the video data to the security server.

In accordance with any of the preceding aspect, the resource registry being accessible to the second tenant account comprises making accessible a list of resources to the second tenant account.

In accordance with any of the preceding aspects, the resource registry being accessible to the second tenant account comprises making accessible a digital map graphically identifying locations of resources in a geographical area.

In accordance with any of the preceding aspects, the resource registry indicates a location of a resource.

In accordance with any of the preceding aspects, a resource in the resource registry comprises a vehicle camera.

In accordance with any of the preceding aspects, the vehicle camera is identified by a transit identifier.

In accordance with any of the preceding aspects, the tenant database is a plurality of tenant databases.

In accordance with any of the preceding aspects, the video data associated with the resource is inaccessible to the second tenant account until approval of the request.

In accordance with any of the preceding aspects, prior to the accessing, the method further comprises receiving the request from a computing apparatus and storing the request in a memory of the image processing device and wherein the request is approved at the image processing device.

In accordance with any of the preceding aspects, the accessing comprises retrieving the request from a memory of the image processing device and wherein the request is approved at the image processing device.

In accordance with any of the preceding aspects, the method further comprises precluding the storing of the video data associated with the resource in the tenant database in association with the second tenant account based on the request being denied.

In accordance with any of the preceding aspects, the second tenant account retains partner account privileges for the first tenant account further to the request being denied.

In accordance with any of the preceding aspects, the request is a first request for access to a first resource and the request further comprises a second request for access to a second resource, wherein the method further comprises: precluding the storing of the video data associated with the second resource in the tenant database in association with the second tenant account based on the second request being denied.

In accordance with any of the preceding aspects, the request is approved based on approval criteria associated with the first tenant account.

In accordance with any of the preceding aspects, the approval criteria include receiving approval from one or more user accounts associated with the first tenant account, the one or more user accounts being authorized to approve the request.

In accordance with any of the preceding aspects, the method further comprises determining that the video data associated with the resource is not available for storing at the time of approval of the request, and automatically storing the video data associated with the resource in the tenant database in association with the second tenant account upon determining that it is available for storing.

In accordance with any of the preceding aspects, the method further comprises storing audit trail data associated with the video data.

In accordance with any of the preceding aspects, the audit trail data comprises audit trail data related to the first user account and audit trail data related to the second user account.

In accordance with any of the preceding aspects, the partner account privileges are bidirectional account privileges.

In accordance with any of the preceding aspects, the partner account privileges are unidirectional account privileges.

In accordance with a fifth example aspect, there is provided method for configuring a tenant account to access a resource registry of an unrelated tenant account, the method comprising: maintaining a first tenant account and a second tenant account, the second tenant account being unrelated to the first tenant account; maintaining a resource registry of the first tenant account, the resource registry being indicative of a set of one or more resources associated with the first tenant account; and configuring the second tenant account to include tenant account privileges enabling the second tenant account to access the resource registry of the first tenant account; and displaying the resource registry of the first tenant account at a computing device accessed by the second tenant account.

In accordance with any of the preceding aspects, the one or more resources associated with the first tenant account are associated with video data and wherein access to the video data by the second tenant account requires a request for access to the video data.

### BRIEF DESCRIPTION OF THE DRAWINGS

Reference will now be made, by way of example, to the accompanying drawings which show example embodiments of the present application, and in which:

FIG. 1 is a schematic diagram of an example security system in accordance with example embodiments;

FIG. 2 is a schematic illustrating an example portion of a surveillance domain of an entity;

FIG. 3 is a block diagram illustrating an example processing system suitable for implementing an image processing device;

FIG. 4 is a block diagram illustrating an example processing system suitable for implementing a server in the security system of FIG. 1;

FIG. 5 is a schematic diagram illustrating a first embodiment of a non-limiting exemplary graphical user interface for viewing a resource registry of an entity;

FIG. 6 is a schematic diagram illustrating illustrating a second embodiment of a non-limiting exemplary graphical user interface for viewing a resource registry;

FIG. 7 is a block diagram illustrating an example processing system suitable for implementing a computing device;

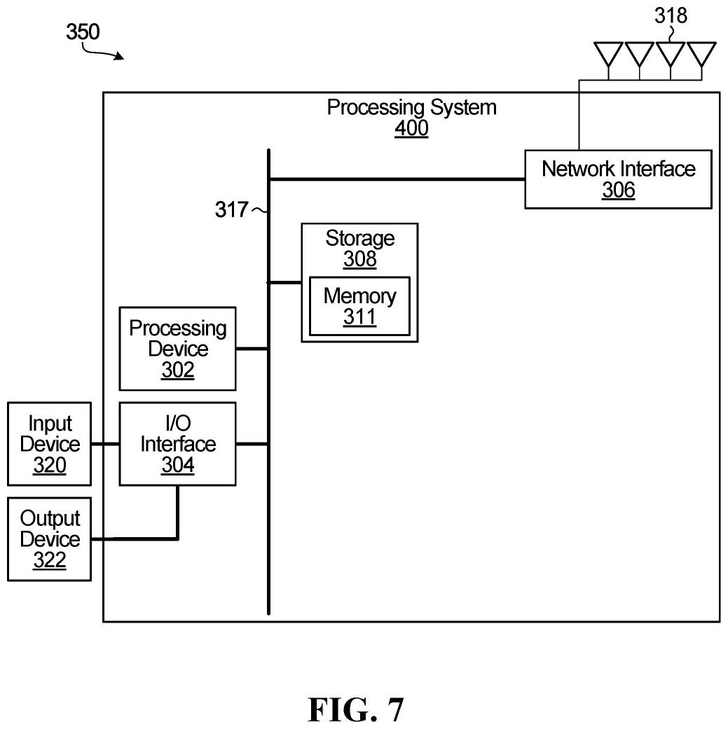

FIG. 8 is a flow chart illustrating a method for configuring a tenant account to access a resource registry of an unrelated tenant account in accordance with example embodiments;

FIG. 9 is a flow chart illustrating a method for sharing video data across tenants of a multi-tenant security system in accordance with example embodiments;

FIG. 10 is a flow chart illustrating a method for sharing video data across tenants of a multi-tenant security system for execution by an image processing device in accordance with example embodiments;

FIG. 11 is a schematic diagram of an alternative example security system in accordance with an alternative example embodiment;

FIG. 12. is a functional representation of the server, including a resource access module of the server, a device interface module, a set of tenant databases and a tenant directory, in accordance with a non-limiting embodiment;

FIG. 13A is an embodiment of a non-limiting exemplary graphical user interface for generating a resource sharing request; and

FIG. 13B is an embodiment of a non-limiting exemplary graphical user interface for viewing a resource sharing request; and

FIG. 14. is a functional representation of an image processing device, including a resource access module of the image processing device, a device interface module, a set of tenant databases and a tenant directory, in accordance with a non-limiting embodiment.

In the drawings, embodiments are illustrated by way of example. It is to be expressly understood that the description and drawings are only for purposes of illustrating certain embodiments and are an aid for understanding. They are not intended to be a definition of the limits of the invention.

### DESCRIPTION OF THE EMBODIMENTS

The present disclosure is made with reference to the accompanying drawings, in which certain embodiments are shown. However, the description should not be construed as limited to the embodiments set forth herein. Rather, these embodiments are provided as examples. Also, like numbers refer to like elements throughout. Separate boxes or illustrated separation of functional elements or modules of illustrated systems and devices does not necessarily require physical separation of such functions or modules, as communication between such elements can occur by way of messaging, function calls, shared memory space, and so on, without any such physical separation. As such, functions or modules need not be implemented in physically or logically separated platforms, although they are illustrated separately for ease of explanation herein. Different devices can have different designs, such that while some devices implement some functions in fixed function hardware, other devices can implement such functions in a programmable processor with code obtained from a machine-readable medium.

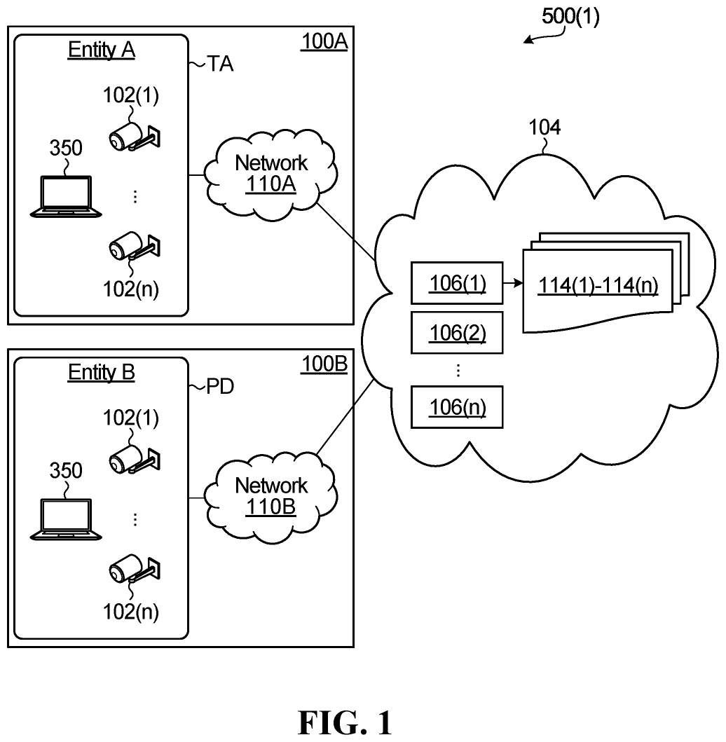

FIG. 1 is a schematic diagram illustrating a non-limiting example of security systems 100A, 100B each comprising a plurality of electronic devices 102(1)-102(n) (generically referred to as electronic device 102) respectively belonging to an entity (e.g., individual, company, organization, association, etc.) and one or more computing devices 350. In the example of FIG. 1, the electronic devices 102(1)-102(n) are image processing devices (cameras) which are at least part of a monitoring system of respective entities denoted as Entity A and Entity B.

The cameras 102 capture and collect data pertaining to a geographic area (e.g., a residence, a business, a public space, a neighborhood, a community, a vehicle, or a parking lot) to monitor objects, events, places, and/or people of interest within the geographical area and ensure security of the geographic area.

The security systems 100A, 100B may comprise a number (n) of cameras 102, for instance cameras 102(1), 102(2), . . . , and 102(n), disposed at various locations within a geographical area. It should be understood that any suitable number of cameras 102 may apply. The cameras 102 may be located in close proximity to one another, for instance in the same building or on the same city block, or they may be remote from one another, for instance, located in different parts of the same city or in different cities altogether.

For brevity, the foregoing description will focus on a single camera 102 with the understanding that this description may apply to one or more of the cameras 102(1)-102(n).

The camera 102 may comprise any suitable image processing device. For instance, in some cases the camera 102 may be an analog camera, an IP (internet protocol) camera, a mobile phone, a body-worn camera, a vehicle camera, a camera of an unmanned aerial vehicles, in accordance with a few non-limiting examples.

In some cases, the camera 102 may be a stationary image processing device (i.e., a non-moving image processing device). In other cases, the camera 102 may be a non-stationary image processing device (i.e., a moving image processing device) such as a body-worn camera, a vehicle camera, a camera of an unmanned aerial vehicle camera, to name a few non-limiting examples.

As used herein, the expression “vehicle camera” refers to any moving image processing device installed in or on a vehicle. A vehicle camera may be part of a driver assistance system or implemented as an event data recorder (e.g., a dashboard camera, a backup camera, a license plate recognition camera, etc.).

A non-limiting example configuration of a camera 102 will now be discussed in greater detail below.

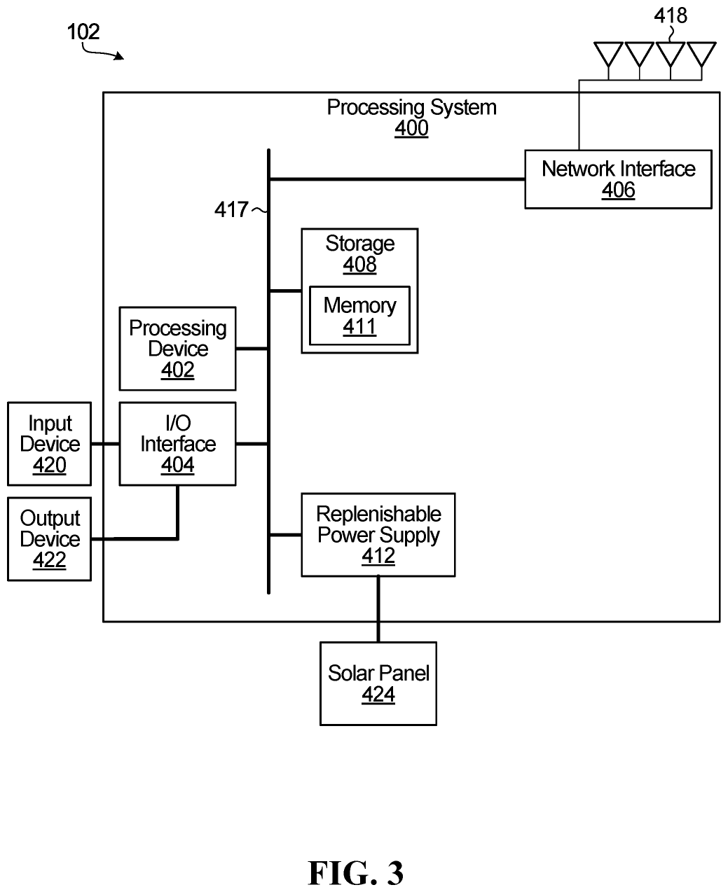

FIG. 3 is a block diagram of non-limiting example illustrating an example processing system suitable for implementing the camera 102. Although FIG. 3 may show a single instance of each component, there may be multiple instances of each component in the camera 102.

The camera 102 comprises a suitably configured wireless transceiver 418 for exchanging at least data communications over a network 110A, 110B. The wireless transceiver 418 could include one or more radio-frequency antennas. The wireless transceiver 418 could be configured for cellular communication or Wi-Fi communication. The wireless transceiver 418 may also comprise a wireless personal area network (WPAN) transceiver, such as a short-range wireless or Bluetooth® transceiver, for communicating with a computer (not shown) or other Bluetooth® enabled devices such a smartphone. The wireless transceiver 418 can also include a near field communication (NFC) transceiver. The wireless transceiver 418 is connected to a processing system 400, specifically via a network interface 406 of the processing system 400.

The camera 102 also includes an input device 420 such as comprising at least one optical sensor. The optical sensor may also be referred to as an image sensor. The input device 420 may also include a microphone for capturing audio. The camera 102 is configured to capture images or video in accordance with specific image capture parameters. In some examples, the image capture parameters may include at least one of frame rate, image resolution, number of images captured over a given time period, and activation of flash.

The processing system 400 may include a processing device 402, such as a central processing unit (CPU), a graphics processing unit (GPU), a tensor processing unit (TPU), a neural processing unit (NPU), an application-specific integrated circuit (ASIC), a field-programmable gate array (FPGA), a dedicated logic circuitry, or combinations thereof.

The processing system 400 may also include a storage unit 408, which may include a mass storage unit such as a solid state drive, a hard disk drive, a magnetic disk drive and/or an optical disk drive. In some examples, the storage unit 408 may store the images or videos captured by the camera 102.

The images or videos can be sent in the form of datagrams (packets) over the network 110A, 110B via the network interface 406 and the wireless transceiver 418. Proper addressing of the datagrams can allow them to be routed by the network 110A, 110B to a server 104 (which will be described below). Transmission of the images or videos can be carried out in accordance with specific transmission parameters. The transmission parameters include at least one of bandwidth, duration of transmission (or transmission duty cycle), modulation scheme, and data rate. When the camera 102 is initially set up, the transmission parameters may be set to respective default values.

The processing system 400 may also include an instruction memory 411, which may include a volatile or non-volatile memory (e.g., a flash memory, a random-access memory (RAM), a read-only memory (ROM), an erasable programmable ROM (EPROM), an electrically erasable programmable ROM (EEPROM), a flash memory and a CD-ROM, to name a few non-limiting possibilities). The instruction memory 411 may store instructions for execution by the processing device 402, such as to carry out example methods described in the present disclosure. The instruction memory 411 may store other software (e.g., instructions for execution by the processing device(s) 402), such as an operating system and other applications/functions.

In other embodiments, the processing system 400 may include a replenishable power supply 412, which is referred to as an “off-grid” power supply. The replenishable power supply 412 may be a battery, which is coupled to a solar panel 424 such that the battery could be replenished. Thus, the camera 102 be a solar-powered camera, which could be powered by sunlight, through electricity generated by the solar panel(s) 424.

There may be a bus 417 providing communication among the components of the processing system 400, including the processing device 402, the I/O interface 404, the network interface(s) 406, storage unit 408, memory 411 and replenishable power supply 412. The bus 417 may be any suitable bus architecture including, for example, a memory bus, a peripheral bus and/or a video bus.

Additional components may be provided. For example, the camera 102 may include an output device 422 such as a display and/or a visual or audible alarm, which may be controlled by the processing system 400.

The camera 102 may additionally communicate with a computer or other user device over a physical link such as a data port (e.g., USB port) forming part of the I/O interface 404, which can occur during device setup or diagnostics testing, for example.

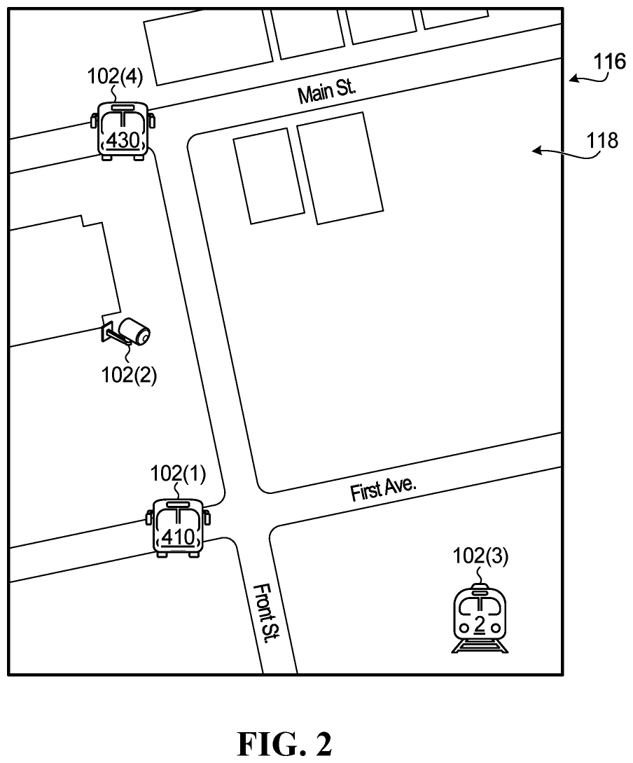

With reference to FIG. 2, there is shown a schematic diagram illustrating an example portion of a surveillance domain 116 of an entity which will be referred to as Entity A. In this example, Entity A is a transit authority referred to as “transit authority TA”. The portion of the surveillance domain 116 shown in FIG. 2 shows a geographical area 118 includes a number of cameras identified as cameras 102(1), 102(2), 102(3) and 102(4). The cameras 102(1), 102(2), 102(3) and 102(4) belong to Entity A and are disposed in the geographical area 118 of the surveillance domain 116 of Entity A. The cameras 102(1), 102(2), 102(3) and 102(4) are configured to capture and collect data of the geographic area 118 (e.g., a residence, a business, a public space, a neighborhood, a community, a vehicle, or a parking lot) to monitor objects, events, places, and/or people of interest within the geographical area and ensure security of the geographic area 118.

In this example, the cameras 102(1), 102(4) are cameras aboard buses identified respectively as bus “410” and bus “430”, the camera 102(2) is a camera aboard a train identified as train “2” and the camera 102(3) is a camera located at a train station. In this example, cameras 102(1), 102(3) and 102(4) are non-stationary image processing devices (i.e., a moving image processing device) and camera 102(2) is a stationary image processing device (i.e., a non-moving image processing device). In this example cameras 102(1), 102(3) and 102(4) are vehicle cameras.

With respect to security system 100A, the images or videos from the cameras 102(1), 102(2), 102(3) and 102(4) belonging to Entity A are sent over the network 110A to the server 104. Similarly, with respect to security system 100B, the cameras 102(1)-102(n) belonging to Entity B are sent over the network 110B to the server 104.

The cloud server 104 runs in a cloud computing environment. The cloud server 104 provides cloud-based services to a plurality of different respective entities which are customers utilizing cloud-based services provided by a cloud-based service provider. These customers can be referred to as “tenants” of the cloud computing environment and the cloud computing environment in which the cloud server 104 runs may be referred to as a “multi-tenant” cloud computing environment. In this way, the security systems 100A, 100B are part of a multi-tenant security system 500(1) (or “security system 500(1)”). The multi-tenant security system 500(1) includes the security systems 100A, 100B and the cloud server 104.

In this embodiment, the cloud-based services provided by the cloud server 104 include digital evidence management services. Digital evidence management services may be provided to the tenants of the multi-tenant cloud computing environment to facilitate storing, organizing, searching and analyzing digital evidence within a single digital evidence management system, to provide a few non-limiting examples.

For instance, the video data collected from one or more of the cameras 102(1)-102(n) may constitute digital evidence in the context of an investigation of an incident. This digital evidence may be handled by the security system 500(1).

In addition to digital evidence management services, the cloud server 104 could provide additional cloud-based services to the plurality of the different entities. For instance, the cloud server 104 could also provide video management services. Video management services may be provided to the tenants of the multi-tenant cloud computing environment to facilitate archiving video data, managing and controlling the cameras 102, processing video data to perform video analytics, providing access to camera video feeds within a video management system, to provide a few non-limiting examples.

As such, the cloud server 104 may be considered as providing cloud-based security services to a plurality of different respective entities such that the cloud server 104 can be referred to as a security server 104 of the security system 500(1). Thus, in this example, the security system 500(1) may be configured to include both a video management system and a digital evidence management system.

In this example, the digital evidence management services and the video management services are provided by the same server (i.e., the security server 104). In other examples, the digital evidence management services and the video management services are provided by the different servers.

Each tenant is associated with a respective tenant account 106(1)-106(n) (generically referred to as tenant account 106) at the cloud server 104. In the non-limiting example of FIG. 1, the plurality of tenant accounts may include a first tenant account 106(1) and a second tenant account 106(2). In this non-limiting example, the first tenant account 106(1) is associated with the Entity A (the transit authority TA) and the second tenant account 106(2) is associated with the Entity B which is a police department referred to as “police department PD”.

In the example of FIG. 1, the security server 104 could provide one or more cloud-based services for a respective tenant account 106(1)-106(n) and store data associated with the respective tenant accounts 106(1)-106(n). Although the security server 104 stores data for the different respective tenant accounts 106(1)-106(n) and provides services for the different respective tenant accounts 106(1)-106(n), a given one of the tenant accounts 106(1)-106(n) is not allowed to access data and services corresponding to another one of the tenant accounts 106(1)-106(n). The data and services for the given one of the tenant accounts 106(1)-106(n) are segregated from data and services of the other ones of the tenant accounts 106(1)-106(n) and are only accessible to the given one of the tenant accounts 106(1)-106(n).

The camera 102 communicates with the security server 104 over a network 110 to transmit the collected data to the security server 104. In some embodiments, the network 110 may include a radio access network (RAN) such as a cellular network. In other embodiments, the network 110 may be part of a wireless local area network (WLAN). The WLAN may comprise a wireless network which conforms to IEEE 802.11x standards (sometimes referred to as Wi-Fi®). Other configurations of the wireless network are possible in other embodiments. In addition, the network 110 has an infrastructure that supports a data communication protocol, such as a data exchange protocol (e.g., UDP or TCP/IP). In an example embodiment, the network 110 could be the Internet.

In one example of implementation, as shown in FIG. 1, given ones of the cameras 102(1)-102(n) belonging to the Entity A (the transit authority TA) communicate with the security server 104 over the network 110A to transmit the collected data to the security server 104 and the collected data is stored in association with the tenant account 106(1). Similarly, given ones of the cameras 102(1)-102(n) belonging to the Entity B (the police department PD) communicate with the security server 104 over a network 110B to transmit the collected data to the security server 104 and the collected data is stored in association with the tenant account 106(2).

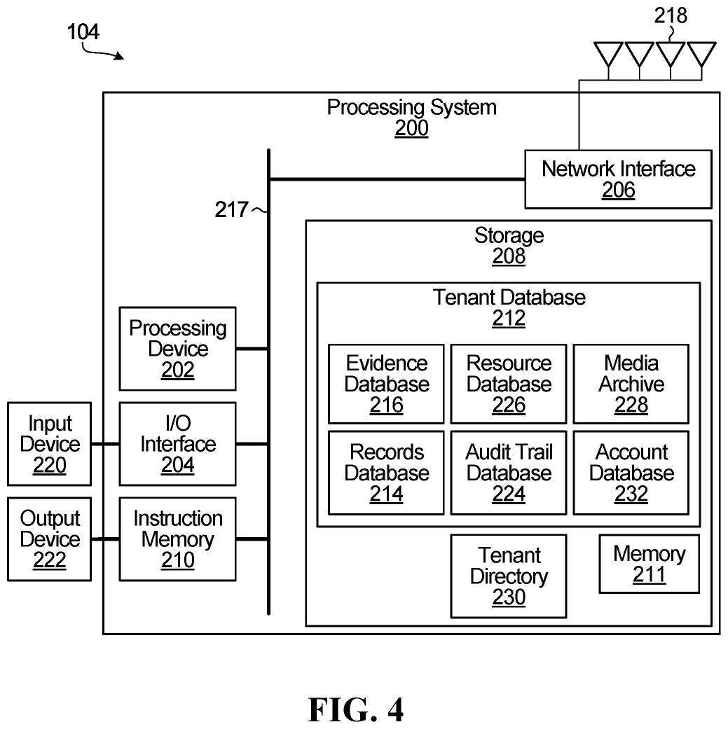

FIG. 4 is a block diagram of an example simplified processing system 200, which may be used to implement the security server 104. Although FIG. 4 shows a single instance of each component, there may be multiple instances of each component in the security server 104.

The processing system 200 may include one or more network interfaces 206 for wired or wireless communication with the communication networks 110A, 110B or with other servers. The wired communication may be established via Ethernet cable. In addition, the processing system 200 comprises a suitably configured wireless transceiver 218 for exchanging at least data communications over wireless communication links. The wireless transceiver 218 could include one or more radio-frequency antennas. The wireless transceiver 218 could be configured for cellular communication or Wi-Fi communication. The wireless transceiver 218 may also comprise a wireless personal area network (WPAN) transceiver, such as a short-range wireless or Bluetooth® transceiver, for communicating with the other servers. The wireless transceiver 218 can also include a near field communication (NFC) transceiver. The wireless transceiver 218 is connected to a processing system 200, specifically via a network interface 206 of the processing system 200.

The processing system 200 may include a processing device 202, such as a central processing unit (CPU), a graphics processing unit (GPU), a tensor processing unit (TPU), a neural processing unit (NPU), an application-specific integrated circuit (ASIC), a field-programmable gate array (FPGA), a dedicated logic circuitry, or combinations thereof.

The processing system 200 may include one or more input/output (I/O) interfaces 204, to enable interfacing with one or more input devices 220 and/or output devices 222.

The processing system 200 may also include a storage unit 208, which may include a mass storage unit such as a solid state drive, a hard disk drive, a magnetic disk drive and/or an optical disk drive. In some examples, the storage unit 208 may store at least one of video data, audio data, image data, digital evidence, case information, tenant information and resource information associated with each of the tenant accounts 106(1)-106(n).

The processing system 200 may also include an instruction memory 211, which may include a volatile or non-volatile memory (e.g., a flash memory, a random-access memory (RAM), a read-only memory (ROM), an erasable programmable ROM (EPROM), an electrically erasable programmable ROM (EEPROM), a flash memory and a CD-ROM, to name a few non-limiting possibilities). The instruction memory 211 may store instructions for execution by the processing device 202, such as to carry out example methods described in the present disclosure. The instruction memory 211 may store other software, such as an operating system and other applications/functions.

Additional components may be provided. For example, the processing system 200 may comprise an input/output interface 204 for interfacing with a user (e.g., an operator or an administrator) via input and/or output devices 220, 222, such as a display, keyboard, mouse, touchscreen and/or haptic module, for example. In FIG. 2, the input and output device 220, 222 are shown as external to the processing system 200. This is not intended to be limiting. In other examples, one or more of the input device 220 and the output device 222 may be integrated together and/or with the processing system 200. For example, the input device 220 and the output device 222 may be integrated as a single component.

There may be a bus 217 providing communication among components of the processing system 200, including the processing device 202, input/output interface 204, network interface 206, storage unit 208, and/or instruction memory 211. The bus 217 may be any suitable bus architecture including, for example, a memory bus, a peripheral bus or a video bus.

In this embodiment, the storage 208 of the server 104 stores a plurality of data stores 214, 216, 224, 228, 232 which may be collectively referred to as a set of tenant databases 212. Each tenant account 106(1)-106(n) may be associated with a set of tenant databases 212 such that there are n number of sets of tenant databases 212 (212(1), 212(2), . . . , 212(n)). In one non-limiting example, as depicted in FIG. 4, the set of tenant databases 212 includes a media archive 228, an account database 232, a records database 214, an evidence database 216, and an audit trail database 224.

In this example, one or more databases in the set of tenant databases 212 are stored in the storage 208 of the security server 104. In other examples, one or more databases in the set of tenant 212 may be stored remotely from the security server 104.

In this embodiment, video data collected by the camera 102 is provided to the security server 104 for remote storage in a media archive 228. The media archive 228 may store other data such as image data, audio data, and metadata, to name a few non-limiting examples. The data stored in the media archive 228 may be stored indefinitely or may be stored for a shorter period of time based upon use case.

The media archive 228 may be considered to be part of the video management system of the security system 500(1).

The account database 232 stores information related to a tenant account 106 associated with a given entity.

A tenant account 106 associated with an entity may be associated with one or more user accounts 114(1)-114(n) (generically referred to as account 114) assigned to a member (user) associated with the entity. For instance, in one example, the Entity A (the transit authority TA) associated with the tenant account 106(1) may have a number of members (e.g., employees) and one or more of these members may be associated with a user account 114(1).

The account database 232 may store information regarding each of the user accounts 114(1)-114(n). The information may include a name of the member, the role of the member within the entity (e.g., a job title), login credentials associated with the user account 114 (e.g., a user identifier and a user password, etc.), to name a few non-limiting examples. The account database 232 may store any suitable information.

For example, the member associated with the user account 114(1) may connect to the security server 104 with a web application or web browser instantiated at the computing device 350 shown in FIG. 1 (which will be described further below) using the login credentials associated with the user account 114(1) to access video management services provided by the security server 104.

The account database 232 may store information regarding user privileges associated with the each of the user accounts 114(1)-114(n) associated with a given tenant account 106(1)-106(n).

As user account 114 may be associated with user privileges which define actions that a user account 114 is entitled to perform at the server 104. For instance, in some cases, a user account 114 may be enabled with administrator privileges which allow the user account 114 to perform certain actions which would otherwise not be performable by a user account 114 which does not have administrator privileges.

For instance, the transit authority TA may include a security department employing members as security agents and security agent managers, each member being associated with a user account 114(1)-114(n). In one example, a member that is a security agent manager may have administrator privileges associated with their user account 114 and a member that is a security agent may not have administrator privileges associated with their user account 114.

The records database 214 may store case information regarding cases. For instance, each record stored in the records database 214 may be associated with a case which is a collection of information related to an investigation. For example, the case information may include a case identifier (e.g., a case name, a case number), a description of the investigation, a status of the case, a category of the case, a responsible member associated with the case, to list a few non-limiting examples.

The records database 214 may be considered to be part of the digital evidence management system of the security system 500(1).

The evidence database 216 may store digital evidence associated with one or more cases.

Examples of digital evidence include, but are not limited to, video data collected from the camera 102, image data, audio data, digital incident reports, Global Positioning System (“GPS”) coordinates, maps, routes, floor plans, sensor and telemetry readings, criminal and civil records, vehicle ownership records, computer aided dispatch records, biometric data such as iris, fingerprint, vein, or DNA information, data derived by a computer analytic or algorithm, to list a few non-limiting examples.

The video data may be stored in any suitable file format. In this embodiment, the evidence database 216 is file agnostic such that any video file format may be stored as evidence in the evidence database 216.

The digital evidence database 216 may also store metadata related to the digital evidence stored in the digital evidence database 216. For instance, the digital evidence database 216 may store a description of the digital evidence stored therein.

The evidence database 216 may also store links to information stored in the records database 214. For instance, given that each piece of evidence stored in the evidence database 216 is related to a case (an investigation), the evidence database 216 may store links for linking a piece of evidence to its related case in the records database 214.

The evidence database 216 may be indexed for enabling searching of the digital evidence database 216 to identify one or more pieces of digital evidence stored therein.

In some cases, the video data may first be stored in the media archive 228 and may subsequently be stored in the evidence database 216. This may occur upon determination, for example, upon determination by a member of an entity that such video data comprises evidence for a case.

For example, the member associated with the user account 114(1) and connected to the security server 104 may determine that the video data collected by the camera 102 which has been stored in the security server 104 in the media archive 228 as part of the video management system comprises evidence. The member associated with the user account 114(1) may thus decide to export the video data from the media archive 228 to the evidence database 216 such that the video data may be stored as part of the digital management system.

In one example of implementation, a plugin may be provided via the web application or web browser to export the video data from the media archive 228 to the evidence database 216.

Additionally, a case may be created in respect to the investigation involving the video data added to the evidence database 216. As such, a record may be created in the records database 214.

The evidence database 216 may be considered to be part of the digital evidence management system of the security system 500(1).

The audit trail database 224 stores audit trail information for each piece of digital evidence stored in the evidence database 216.

For example, the audit trail information may comprise audit trail data. Audit trail data may be understood as a chronological digital documentation that records a sequence and/or sequences of custody of digital evidence stored in the evidence database 216, including, but not limited to, digital documentation of control, transfer, access, copying, analysis, and/or disposition of digital evidence.

The audit trail data may be generated with any suitable algorithm for example algorithms based on calculating a hash value, checksum or CRC value (a signature value) of the data in a file. In other embodiments, a blockchain may be implemented to store audit trail data.

Additionally, when members of an entity access and/or search for digital evidence in the database 216 via their user account 114 and a computing device (such as the computing device 350), the server 104 maintains a record of such access and/or such a search at the audit trail database 224.

The audit trail data is associated with records of the digital evidence stored in the evidence databases 216. For instance, the audit trail database 224 may store links for linking audit trail data to its related record in the evidence database 216.

The audit trail database 224 may be considered to be part of the digital evidence management system of the security system 500(1).

The resource database 226 stores information related to resources associated with a given one of the tenant accounts 106(1)-106(n). As used herein, “resources” denotes the collection of cameras 102(1)-102(n) as well as identifiers identifying other sources of video data associated with a given one of the tenant accounts 106(1)-106(n).

The information related to resources may include a resource identifier. In some cases, the resource identifier may be a camera identifier (e.g., a name) of the camera 102, a location of a camera 102 and an image representing a field of view of a camera 102, to name a few non-limiting examples.

The information related to resources may also include information regarding non-stationary (moving) cameras. For instance, the information related to resources may be stored for identifying a vehicle associated with a vehicle camera such as a bus line, a train line, a subway line, etc. In such cases, the resource identifier may include a transit identifier. The transit identifier may include a name, direction, line or number for a vehicle (e.g., a bus, a train or subway, etc.).

The information related to resources may include geographical parameters.

In some cases, the geographical parameters may include a location for a stationary camera such as an address at which the resource is located, a floor identifier, a suite identifier or unit identifier to identify a floor, a suite or a unit within a building at which the resource is located, coordinates such as Global Positioning System (GPS) coordinates defining the location of the resource, to name a few non-limiting examples.

In some cases, the geographical parameters may include an exact location of a non-stationary (moving) camera such as a historical path of travel taken by a vehicle associated with the camera at a given time, one or more addresses, one or more transit stop identifier, or one or more GPS coordinates to list a few non-limiting examples. The geographical parameters may also include a projected location of a non-stationary (moving) camera such including a projected path of travel associated with a non-stationary (moving) camera (e.g., the typical route followed by the vehicle associated with the moving camera) or a projected route (e.g., due to detours, construction, road closures) for a particular time in the future.

It is to be understood that the location of a non-stationary camera may be defined at a specific point in time (e.g., a specific date, time, time range, etc.)

The information related to resources may also include scheduling parameters (e.g., hours of operation associated with the vehicle, etc.). The information related to resources may include any suitable information.

The information related to resources may be acquired in any suitable fashion. For instance, in some cases, some or all of the information may be acquired directly from the resource (e.g., the camera 102 and/or the vehicle). For example, the camera 102 may be configured to facilitate providing this information to the security server 104. For instance, a plugin may be installed at the security server 104 to populate the resource database 226 from information provided by the camera 102.

In other cases, some or all of the information for some of the tenant databases 212 may be acquired or entered manually. For instance, a spreadsheet comprising the information related to resources may be stored at the security server 104.

The resource database 226 may be considered to be part of the digital evidence management system of the security system 500(1).

In this embodiment, the security system 500(1) may be configured for displaying information related to the resource database 226 on a graphical user interface generated on an output device 322 of the computing device 350 used by a member of the entity associated with a given one of the tenant accounts 106(1)-106(n). As will be discussed in further detail below, the computing device 350 is in communication with the security server 104 over the network 110A, 110B.

In this embodiment, the security server 104 is configured for generating a graphical user interface displaying a resource registry 120 which is a visual representation of at least portion of the information stored in the resource database 226.

The resource registry 120 may display one or more of resource identifiers, one or more transit identifiers, one or more geographical parameters, one or more scheduling parameters, etc.

In some embodiments, the resource registry 120 may be updated in real-time to reflect changes to the registry 120 (e.g., to reflect changes to a path of travel of a vehicle associated with a moving camera).

In some embodiments, the resource registry 120 may also include metadata related to the resources. For instance, the resource registry 120 may include metadata related to the video data collected by the cameras 102(1)-102(n).

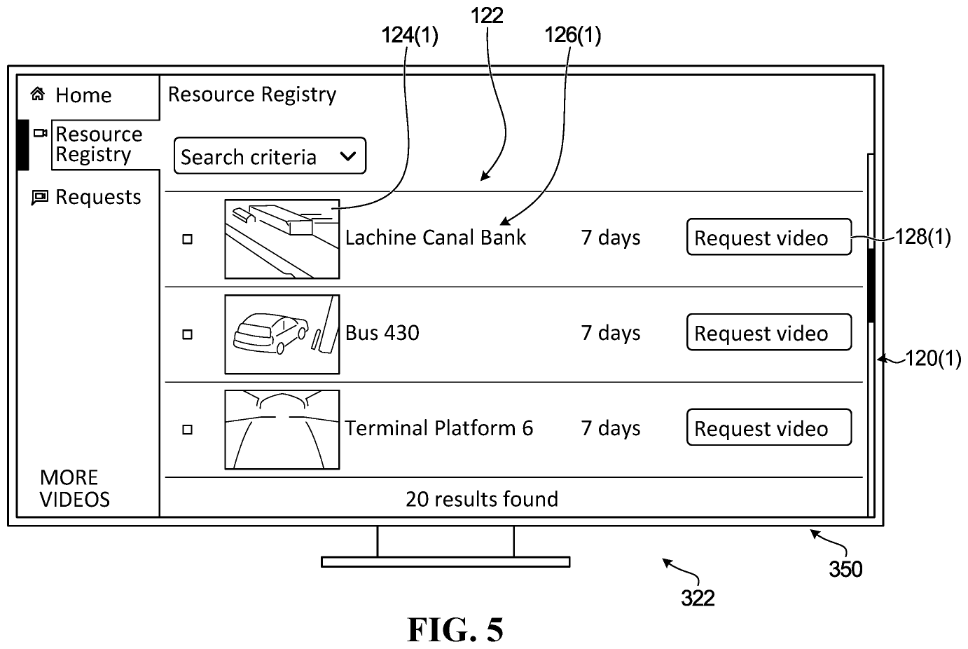

Reference is now made to FIG. 5, illustrating a first embodiment of a non-limiting exemplary graphical user interface for viewing a resource registry 120(1).

In FIG. 5 there is shown a non-limiting exemplary list of resources displayed on a graphical user interface appearing on the output device 322 of the computing device 350.

In this example, the graphical user interface includes a list of the resources 122 associated with the tenant account 106(1). The graphical user interface includes a thumbnail 124(1). In some cases, the thumbnail image 124(1) may represent a field of view of a camera. In other cases, the thumbnail image 124(1) may be a generic image (i.e., an image that is not representative of the field of view of the camera). The graphical user interface also includes an identifier 126(1) (e.g., name) of the given ones of the cameras 102(1)-102(n) and a user-selectable element 128(1) configured to allow a member to request video data associated with any one of the given ones of the camera 102(1)-102(n) listed in the resource registry 120(1).

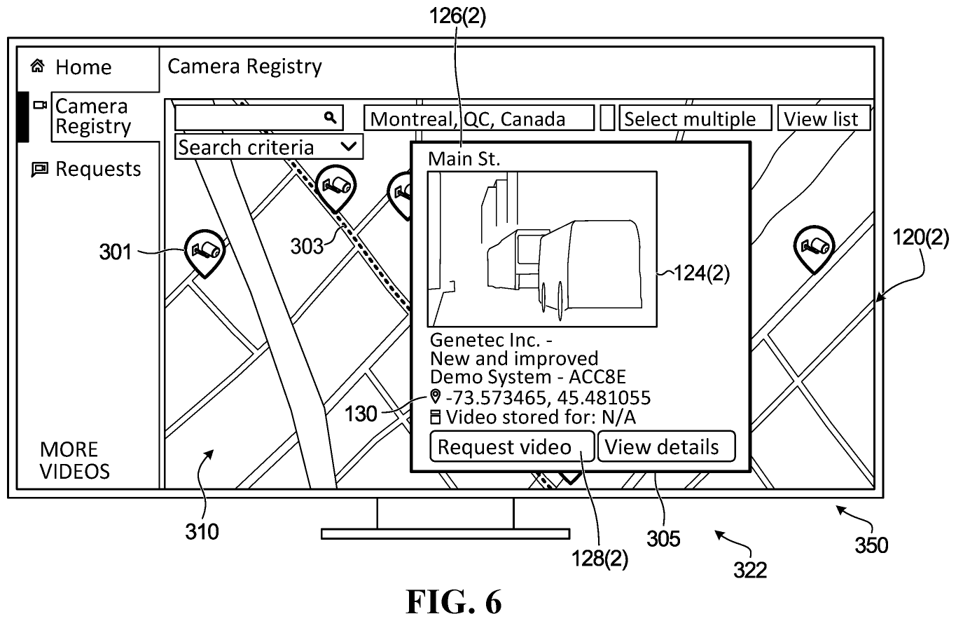

Reference is now made to FIG. 6, illustrating a second embodiment of a non-limiting exemplary graphical user interface for viewing a resource registry 120(2).

In FIG. 6 there is shown an exemplary digital map displayed on a graphical user interface appearing on a display of the output device 322 of the computing device 350.

In this embodiments, one or more graphical user interface elements 301, corresponding respectively to resources associated with a given one of the tenant accounts 106(1)-106(n) is displayed on a digital map 310. The location of each of the one or more graphical user interface elements 301 on the digital map 310 corresponds to the real-life geographical location of the corresponding resource.

In some instances, the one or more additional graphical user interface elements 301 include an icon representing a resource (e.g., a camera 102(1)-102(n)). In some instances, the one or more graphical user interface elements 301 include a symbol or letter representing the nature of the camera (e.g., a stationary camera, a non-stationary camera). In this embodiment, one or more graphical user interface elements 303 correspond to additional information related to a non-stationary camera. For instance, the graphical user interface element 303 represents the route of a train line. In some embodiments, the route of the vehicle as represented by element 303 may be a projected route and in other embodiments, the route of the vehicle as presented by element 303 may be an actual route taken by the vehicle at some point in time. The graphical user interface may be configured to identify the particular time represented by the map 310.

In this example, selecting an element 301, 303 on the map 310 generates a window 305 which displays information regarding the resource associated with the selected element 301. For instance, in one example of implementation, the additional information may include a location of the camera 130, an identifier 126(2) (e.g., name) of the given ones of the cameras 102(1)-102(n) and a user-selectable element 128(2) configured to allow a member to request video data associated with any one of the given ones of the camera 102(1)-102(n) listed in the resource registry 120(2).

In this example, the additional information includes a thumbnail image 124(2). In some cases, the thumbnail image 124(2) may represent a field of view of a camera. In other cases, the thumbnail image 124(2) may be a generic image (i.e., an image that is not representative of the field of view of the camera).

The elements 301, 303, 128 may be selected using any suitable input (e.g., clicking, tapping, touching, swiping, voice command, etc.).

It will be understood that the digital map 310 of FIG. 3 shows an exemplary layout of streets and constructions for purposes of illustration, and that the digital map in accordance with the present teachings varies depending on the layout and geography of the area being depicted on the digital map.

A member of an entity (e.g., Entity A, Entity B) may connect to the security server 104 with a native application, a web application, or web browser to access the digital evidence management services and/or the video management services provided by the security server 104. For example, a member may connect to the security server 104 with a web application or web browser.

A user may access the services provided by the cloud service provider with the computing device 350. The computing device 350 may be a computing device such as a desktop computer, a mobile phone, a tablet, to name a few non-limiting examples.

The computing device 350 may be operated by member(s) to access, view, process, edit and/or analyze information associated with a video feed captured by the cameras 102, case information, audit trail information or camera information, in accordance with some non-limiting examples.

The client computing device 350 may be a remote computing device (i.e., client). One or more client computing devices 300 may be provided, in close proximity to one another, for instance located in the same office or data center, or remote from one another, for instance located in different offices and data centers dispersed across the same city or in different cities altogether.

The computing device 350 has a processing device 302, storage 308, instruction memory 311, I/O interface(s) 324, a network interface 306 that may be linked via bus connections 317. The computing device 110 may have (or be connect to) any suitable I/O device(s) 320, 322, for example, such as a keyboard, a mouse, a touchscreen, etc. The computing device 350 may be a desktop computer, a laptop, a smartphone, a tablet, etc. The computing device 350 has (or is connect to) an output device 322 (e.g., a screen, a tactile display, etc.). The processing device 302, the storage 308, the instruction memory 311, the I/O interface(s) 324, and the network interface 306 may be similar to the processing device 202, the storage 208, the instruction memory 211, the I/O interface(s) 224, and the network interface 206 of the server 104, respectively.

The security system 500(1) may comprise a wide variety of different network technologies and protocols. Communication between the cameras 102, the security server 104, and the client computing device 350 may occur across wired, wireless, or a combination of wired and wireless networks. The security system 500(1) may include any number of networking devices such as routers, modems, gateways, bridges, hubs, switches, and/or repeaters, among other possibilities, communicatively coupled to the cameras 102, security server 104, client computing device 350 and/or at any point along network 110A, 110B.

Considering now a situation wherein an incident has taken place in the geographical area shown in FIG. 2 which is part of the surveillance domain 116 of the transit authority TA (Entity A). In this example, the incident is the subject of an investigation by the police department PD (Entity B). For instance, the police department PD may be investigating a traffic incident in the geographical area 118 shown in FIG. 2 which may have led to heavy breaking by the bus 410 which has allegedly caused injury to passengers of the bus 410. In this case, the police department PD may benefit from having access to the video data collected by one or more of the cameras 102(1)-102(n) of transit authority in the geographical area 118 shown in FIG. 2.

As previously noted, the transit authority TA and the police department PD are respectively associated with the tenant accounts 106(1), 106(2) at the security server 104. Though both the transit authority TA and the police department PD utilize the services of the security server 104 and store data on the security server 104, they do not have access to each other's data. Entity A and Entity B may thus be considered “unrelated entities”. As used herein, “unrelated entities” denotes that the tenant account 106(1) associated with the Entity A does not have access to the services and data of the tenant account 106(2) associated with the Entity B (e.g., Entity A does not have default access to the services and data of the tenant account 106(2) associated with the Entity B), and vice-versa. As such, the tenant accounts 106(1), 106(2) may be referred to as being unrelated.

In typical situations, a member of the police department PD having a user account 114 associated with the tenant account 106(2) is not able to access (e.g., search, view, etc.) the data stored in the security server 104 in association with the tenant account 106(1) of the transit authority TA. For instance, a member of the police department PD assigned to a user account 114(1) does not have access to video data collected by the cameras 102 in the area 118. Moreover, the member of the police department PD does not have access to view the resource registry 120 associated with the transit authority TA.

Below will be described exemplary techniques for enabling sharing video data across tenants of the multi-tenant security system 500(1) of FIG. 1. FIG. 1 illustrates an example in which a member of the police department PD having the user account 114(1) associated with the tenant account 106(2) of the security server 104 wishes to access video data stored for the tenant account 106(1) of the transit authority TA.

### Partner Configuration Process

To permit one or more members of the police department PD to access data associated stored at the security server 104 in association with the transit authority TA, the police department PD (Entity B) must be designated an authorized partner of the transit authority TA (Entity A).

The police department PD may be designated an authorized partner of the transit authority TA by configuring the tenant account 106(2) associated with the police department PD to include partner account privileges such that the tenant account 106(2) is designated a partner account to the tenant account 106(1) associated with the transit authority (Entity A).

As an authorized partner of the transit authority TA, the police department PD may be granted certain privileges with respect to the tenant account 106(1) associated with the transit authority TA. For instance, as an authorized partner of the transit authority TA, one or more members of the police department PD may be authorized to view the resource registry 120 of the transit authority TA. In addition, as an authorized partner of the transit authority TA, one or more members of the police department PD may be authorized to request access to video data collected by the cameras 102(1)-102(n) of the transit authority TA.

Thus, by becoming an authorized partner of the transit authority TA, the police department PD (e.g., one or more members of the police department PD) gains access to at least a portion of the data stored at the security server 104 in association with the first tenant account 106(1) of the transit authority TA.

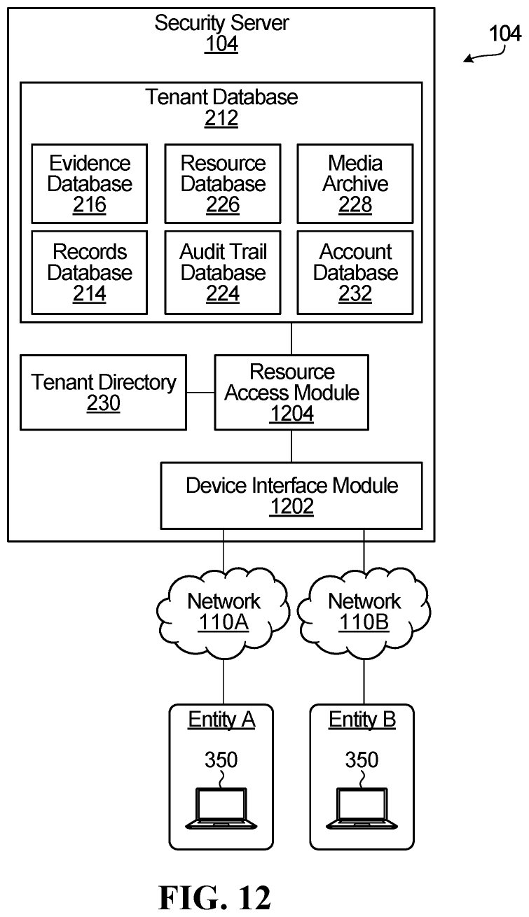

In some examples, execution of the instructions stored in the memory 211 of the server 104 results in the processing system 200 of the security server 104 implementing a resource access module and a device interface module. FIG. 12 is a functional representation of the server 104, including a device interface module 1202, a resource access module 1204, the set of tenant databases 212 and a tenant directory 230.

The device interface module 1202 is configured to manage communications between the resource access module 1204 and the computing devices 350 via the data networks 110A, 110B.

The tenant directory 230 stores information regarding the tenant accounts 106. In this example, the tenant directory 230 stores information regarding a partnership status of the tenant accounts 106. The partnership status is indicative of whether a first one of the tenant accounts 106(1)-106(n) is designated a partner account of a second one of the tenant accounts 106(1)-106(n). In this example, and with reference to FIG. 4, the tenant directory 230 is stored in the storage 208 of the security server 104. In other examples, the tenant directory 230 may be stored remotely from the security server 104.

In one example of implementation, the partnership status may be characterized as “enabled” to indicate that the first one of the tenant accounts 106(1)-106(n) is designated a partner account of the second one of the tenant accounts 106(1)-106(n). In this example of implementation, the partnership status may be characterized as “disabled” indicating that the first one of the tenant accounts 106(1)-106(n) is not designated a partner account of the second one of the tenant accounts 106(1)-106(n).

A given one of the tenant accounts 106(1)-106(n) may be designated a partner account of one or more of the other ones of the tenant accounts 106(1)-106(n).

In some embodiments, an authorized partner may be a bidirectional authorized partner such that second entity is an authorized partner of the first entity and the first entity is an authorized partner of the second entity. In this case, the partner account privileges are bidirectional account privileges.

In this example, by designating the police department PD an authorized partner of the transit authority TA, the transit authority TA is designated an authorized partner of the police department PD. As such, as a result of designating the tenant account 106(2) of the police department PD a partner account of the tenant account 106(1) transit authority, the tenant account 106(1) of the transit authority TA is also designated a partner account of the tenant account 106(2) of the police department PD. In this case, bidirectional configuration of the partner account privileges occurs automatically (e.g., without manual intervention by a member of either entity). In this case, bidirectional configuration of the partner account privileges is performed by the security server 104.

In other embodiments, an authorized partner may be a unidirectional authorized partner such that the first entity may be an authorized partner of the second entity, but the second entity is not an authorized partner of the first entity. In this case, the partner account privileges are unidirectional account privileges.

In one example of implementation of such embodiments, by designating a first one of the tenant accounts 106(1)-106(n) a partner account to a second one of the tenant accounts 106(1)-106(n), the second one of the tenant accounts 106(1)-106(n) is not designated a partner account of the first one of the tenant accounts 106(1)-106(n).

The resource access module 1204 is configured to carry out a partner privileges configuration method 800. The partner privileges configuration method 800 is implemented to designate a first one of the tenant accounts 106(1)-106(n) a partner account to a second one of the tenant accounts 106(1)-106(n). In this way, the partner privileges configuration method 800 is a process for configuring a tenant account to access a resource registry of an unrelated tenant account. To this end, the resource access module 1204 has access to the partnership status of the tenant accounts 106(1)-106(n) and stored as part of the tenant databases 212 and/or the tenant directory 230. The set of tenant databases 212 and the tenant directory 230 are communicatively coupled to the resource access module 1204.

In some embodiments, the web application or web browser instantiated at the computing device 350 for accessing the security services of the security server 104 may have a user interface configured for enabling a member of the first entity to designate a second entity an authorized partner of the first entity. For instance, a member of the first entity may, from their user account 114 designate their tenant account 106 a partner account of another one of the tenant accounts 106.

In some embodiments, the web application or web browser instantiated at the computing device 350 for accessing the security services of the security server 104 may have a user interface configured for enabling a member of the second entity to request that their organization be designated an authorized partner of the first entity. For instance, a member of the second entity may, from their user account 114 request that their tenant account 106 be designated a partner account of another one of the tenant accounts 106. Other suitable means to prompt a tenant account 106 to be designated a partner account are possible.

In one example, a member of the police department PD may request the police department PD be designated an authorized partner of the transit authority TA. The member of the police department PD may from the web application instantiated on their computing device 350 and using their user account 114(2) send the request to the resource access module 1204 via device interface module 1202.

In one example of implementation, once this request (which may be referred to as a “configuration request”) is received by the resource access module 1204, the resource access module 1204 may be configured to determine if the user account 114(1) is authorized to send a configuration request on behalf of the tenant account 106(2) associated with the police department PD.

In some embodiments, only a subset of the user accounts 114(1)-114(n) of a tenant account 106(1)-106(n) may be afforded with privileges to send configuration requests on behalf that tenant account 106(1)-106(n). For instance, in this case, only user accounts 114(1)-114(n) configured with administrator privileges may be afforded with privileges to send configuration requests on behalf that tenant account 106(1)-106(n).

Information regarding the user accounts 114(1)-114(n) configured with privileges allowing configuration requests to be sent may be stored in the account database 232 and/or the tenant directory 230.

In this example, a member of the transit authority TA may be notified that a configuration request has been sent. For instance, the resource access module 1204 may be configured to send a notification to the computing device 350 associated with the transit authority TA via the device interface 1202. In some embodiments, the notification can include an electronic notification in the form of a text message, an email, a push-notification and the like.

Further to receipt of the notification, from the web application instantiated on the computing device 350 and using their user account 114(1), the member of the transit authority TA may designate the tenant account 106(2) associated with the police department PD a partner account of the tenant account 106(1) associated with the transit authority TA.

In some embodiments, only a subset of the user accounts 114(1)-114(n) of a tenant account 106(1)-106(n) may be afforded with privileges to allow configuration of a tenant account 106(1)-106(n) as a partner account. For instance, in this case, only user accounts 114(1)-114(n) configured with administrator privileges may allow configuration of a tenant account 106(1)-106(n) as a partner account.

Information regarding the user accounts 114(1)-114(n) configured with privileges allowing designation of a tenant account 106 as a partner account may be stored in the account database 232 and/or the tenant directory 230.

In some embodiments, at least one member of the first entity and at least one member of the second entity may be required to allow designation of an entity as an authorized partner. In such embodiments, at least one user account 114(1)-114(n) associated with the first entity and at least one user account 114(1)-114(n) associated with the second entity is required to allow configuration of a tenant account 106(1)-106(n) a partner account. In one embodiment, a notification may be sent to the resource access module 1204 via the device interface module 1202, the notification being indicative of the member of the transit authority TA has approved the configuration request so as to designate the tenant account 106(2) associated with the police department PD a partner account of the tenant account 106(1) associated with the transit authority TA. Accordingly, the resource access module 1204 may be configured to modify the partnership status of the police department PD in the tenant directory 230 and/or the account database(s) 232.

As previously stated, once a first one of the tenant accounts 106(1)-106(n) is designated a partner account of a second one of the tenant accounts 106(1)-106(n), at least a portion of the resource database 226 associated with the second one of the tenant accounts 106(2) may be accessible to the first one of the tenant accounts 106(1)-106(n).

For instance, the second tenant account 106(2) may be granted access to the resource database 226 associated with the first tenant account 106(1) by linking the resource database 226 associated with the first tenant account 106(1) to the set of tenant databases 212 associated with the second tenant account 106(2). In this regard, the resource access module 1204 may be configured to access the resource database 226 associated with the first tenant account 106(1) and part of the set of tenant databases 212 to link the resource database 226 associated with the first tenant account 106(1) to the set of tenant databases 212 associated with the second tenant account 106(2).

In other embodiments, the resource database 226 may be kept separate from the set of tenant databases 212 of the second tenant account 106(2) and yet be accessible to the second tenant account 106(2).

In this embodiment, the resource registry 120 is displayed at the web browser in association with the second tenant account 106(2) and is accessible by a member of the entity associated with the second user account 106(2). The resource registry 120 may be rendered accessible by being displayed on the output device 322 of the computing device 350 as was previously discussed. For instance, the resource registry 120 may be accessible to the second tenant account 106(2) by making accessible a list of resources to the second tenant account 106(2). In other cases, the resource registry 120 may be accessible to the second tenant account 106(2) by making accessible a map 310 graphically identifying locations of resources in a geographical area.

In this regard, the resource access module 1204 is configured for generating a graphical user interface for displaying the resource registry 120 described above. In other embodiments, the computing device 350 is configured for generating a graphical user interface displaying the resource registry 120 described above.

At any point after the second entity has been designated an authorized partner of the first entity, the partnership may be modified. For instance, a bidirectional partner may change do a unidirectional partner (or vice versa). In yet another example, a bidirectional partner or a unidirectional partner may no longer be an authorized partner of another entity.

Thus, at any point after the second tenant account 106(2) has been designated a partner account of the first user account 106(2), the partner account privileges may be modified. For instance, the partner account privileges of the second tenant account 106(2) may be revoked. For instance, the partner account privileges of the second tenant account 106(2) may be changed to be one of bidirectional account privileges or unidirectional account privileges. In some embodiments, the change may made by a user account 114 with administrator privileges. In other embodiments, the change may be made by any user account 114.

The resource access module 1204 interfaces with the computing device 350 via the device interface module 1202 to handle requests from the computing devices 350 to modify the partner account privileges of a tenant account 106(1)-106(n).

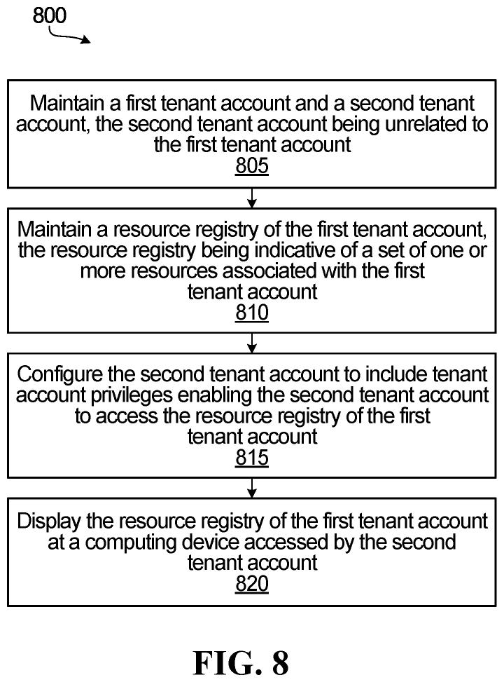

With reference therefore to FIG. 8, it will be appreciated that there has been provided a partner privileges configuration method 800 for configuring a tenant account to access a resource registry of an unrelated tenant account. FIG. 8 is an example flowchart representing the partner privileges configuration method 800 carried out by the resource access module 1204.

At step 805, the method comprises maintaining a first tenant account and a second tenant account, the second tenant account being unrelated to the first tenant account.

At step 810, the method comprises maintaining a resource registry of the first tenant account, the resource registry being indicative of a set of one or more resources associated with the first tenant account.

At step 815, the method comprises configuring the second tenant account to include tenant account privileges enabling the second tenant account to access the resource registry of the first tenant account.

At step 820, the method comprises displaying the resource registry of the first tenant account at a computing device accessed by the second tenant account.

### Management of Resource Sharing Requests

It is to be noted that although a second entity is designated an authorized partner of a first entity, the second entity does not automatically have access to the data of the first entity. For instance, the second entity does not automatically gain access to the to the video data associated with the resources of the first entity.

As such, access to the video data by the second tenant account 106(2) requires a request for access to the video data.

The resource access module 1204 is configured to carry out a resource sharing method 900. The resource sharing method 900 is implemented to manage resource sharing requests from a first one of the tenant accounts 106(1)-106(n) that is a partner account to a second one of the tenant accounts 106(1)-106(n).

After or concurrently with designating the second entity an authorized partner of the first entity such that the second tenant account 106(2) is configured to include partner account privileges, a member of the second entity may request access to a resource of the first tenant. For example, a member of the police department PD may request access to one or more resources of the transit authority TA to assist in the investigation of the aforementioned alleged braking incident.

It should also be noted that the request to access a resource of the first entity by the second entity may be denied even if the second entity is an authorized partner of the first entity. Thus, access by the second entity to a resource of the first entity is conditional on the approval of the request by the first entity.

By being designated an authorized partner, the second entity may request access to a resource of the first entity without being invited to access the resource by the first entity.

Aspects related to requesting access to a resource of an entity will be described with reference to the transit authority TA and the police department PD. It is understood that that such a description is exemplary in nature and is not to be considered limiting.

In some embodiments, the web application or web browser instantiated at the computing device 350 for accessing the security services of the security server 104 may have a user interface configured for enabling a member of the police department PD to access to a resource in the resource registry of the police department PD. The request is a request from the second tenant account 106(2) to access a resource included in the resource registry of the first tenant account 106(1). The request may be referred to as a “resource sharing request.” As previously indicated, the resource registry 120 is accessible to the second tenant account 106(2) based on the partner account privileges.

As shown in FIGS. 5 and 6, in one example, the graphical user interface for displaying the resource registry is configured for initiating such requests. The member of the police department PD may from the web application instantiated on their computing device 350 and using their user account 114(1) may generate the resource sharing request. In one example of implementation, the resource access module 1204 is configured for generating a graphical user interface at the computing device 350, via device interface module 1202, for requesting access to a resource. In other embodiments, the computing device 350 is configured for generating a graphical user interface for requesting access to a resource.

For instance, the request may in some cases include a selection by the second tenant account 106(2) of a resource included in the resource registry 120 of the first tenant account 106(1). The selection may be made with any suitable user input (e.g., clicking, tapping, touching, swiping, voice command, etc.). For instance, the selection may be made by way of the user-selectable element 128(1), 128(2) displayed on the output device 322 of the computing device 350 and configured to allow a member to request video data associated with any one of the given ones of the camera 102(1)-102(n) listed in the resource registry 120(1), 120(2).

In some embodiments, the tenant account 106(2) may be configured to be a partner account to several other ones of the tenant accounts 106. In such embodiments, in order to access a resource of the tenant account 106(1), the member of the police department PD may be required to provide user input indicative of a selection of the first tenant account 106(1) in order to initiate the request.

The request may include a plurality of request parameters. In some cases, the request parameters include parameters for identifying the resource for which access is being requested.

For instance, the request may include a resource identification parameter for identifying the resource. For example, the identification parameter may be a camera identifier such as a name of the camera or a transit identifier such as a name, direction, line or number for a bus line, a train line or subway line.

The request may include geographical parameters. For example, the geographical parameters may include an exact location for a stationary image processing device (e.g., an address, floor identifier, suite identifier or unit identifier to identify a floor, a suite or a unit within a building, coordinates such as Global Positioning System (GPS) coordinates, to name a few non-limiting examples). In yet another example, the geographical parameters may include an exact location for a non-stationary camera such as a historical path of travel taken by the vehicle at a given time. The exact location may include one or more addresses, stop identifiers, or coordinates to list a few non-limiting examples. The geographical information may also include a projected path of travel associated with a non-stationary (moving) camera. For instance, a projected route (e.g., due to detours, construction, road closures) for a particular time in the future may be provided.

The information related to resources may include information for denoting operational parameters related to a vehicle associated with a vehicle camera such as geographical parameters (e.g., the typical route followed by the vehicle, projected detours, historical information regarding the location of vehicle)

The request may include temporal parameters such as a date and/or date range, a time and/or time range associated with the video data associated with the resource. The temporal parameters may include scheduling parameters related to a vehicle (e.g., hours of operation associated with the vehicle, etc.)

The request may include a request to search one or more resources. For instance, the request may include a request for access to a first resource of the first tenant account 106(1) and a second resource of the second tenant account 106(1). A single request may be directed to a single resource or a plurality of resources.

The request parameters may be obtained by querying the security server 104.

The security server 104 may be queried from the computing device 350. The security server 104 may receive a search string from the computing device 350.

For example, a member (e.g., a security manager) may operate the computing device 350 (e.g., operating the input device 320) to enter a search string for searching the security server 104 for one or more resources.

For instance, the member of the police department may query the resource registry of the transit authority to determine which resources typically or have gone through the intersection of First Ave and Front Street. Based on the query, it may be determined that a bus designated as Bus 410 and a train designated as Train 2 operate within the queried area.

The query may include a date and/or time range. Upon specifying the date and time range, it is determined that Bus 430 typically does not operate within the queried area, however, the Bus 430 was subject to a detour and indeed went through the queried area at the specified time range.

Thus, the query may identify one or more resources which meet the request parameters. For instance, the query may reveal whether a non-stationary camera may provide relevant video data.

The request may include additional request parameters. The request may include a user identification parameter that identifies the user associated with the user account 114(1) initiating the request. For instance, a user identification parameter may include identification information such as name of the member associated with the user account 114(1), the title of the member, the name of the department to which the member belongs, a badge number of the member, an ID number of the member, an IP address of the computing device 350, and the like.

The request may include a case parameter that identifies a case associated with the request. For instance, the case parameter may include a case number, a case description and the like.

The approval criteria may further require attaching supporting documentation to the request (e.g., subpoenas, court order, etc.).

It is to be understood that the above listed parameters are non-limiting examples of request parameters and that other parameters may be designated depending on the use case.

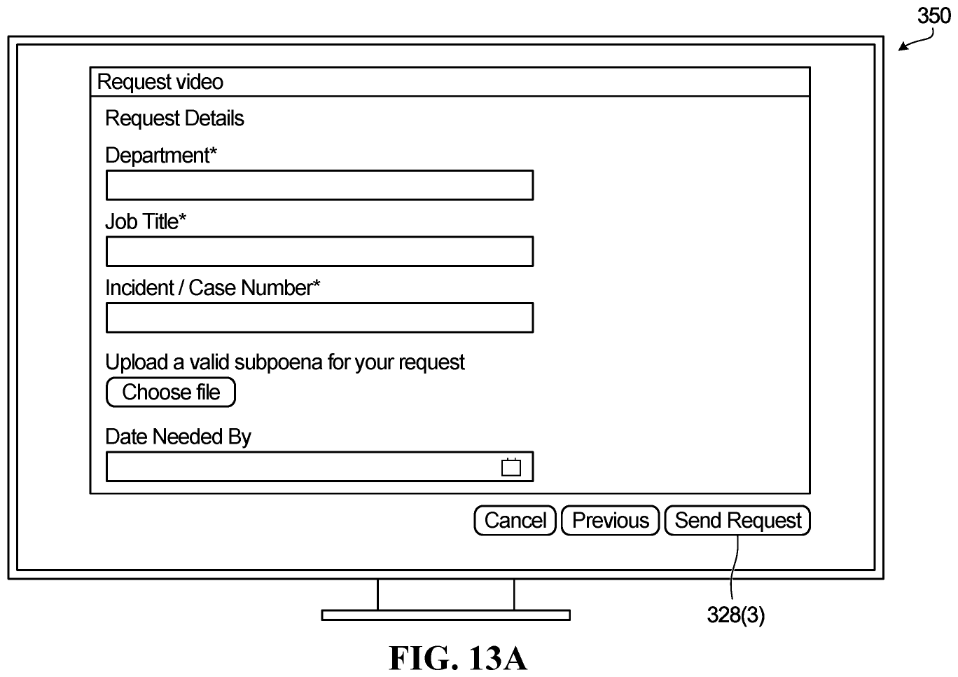

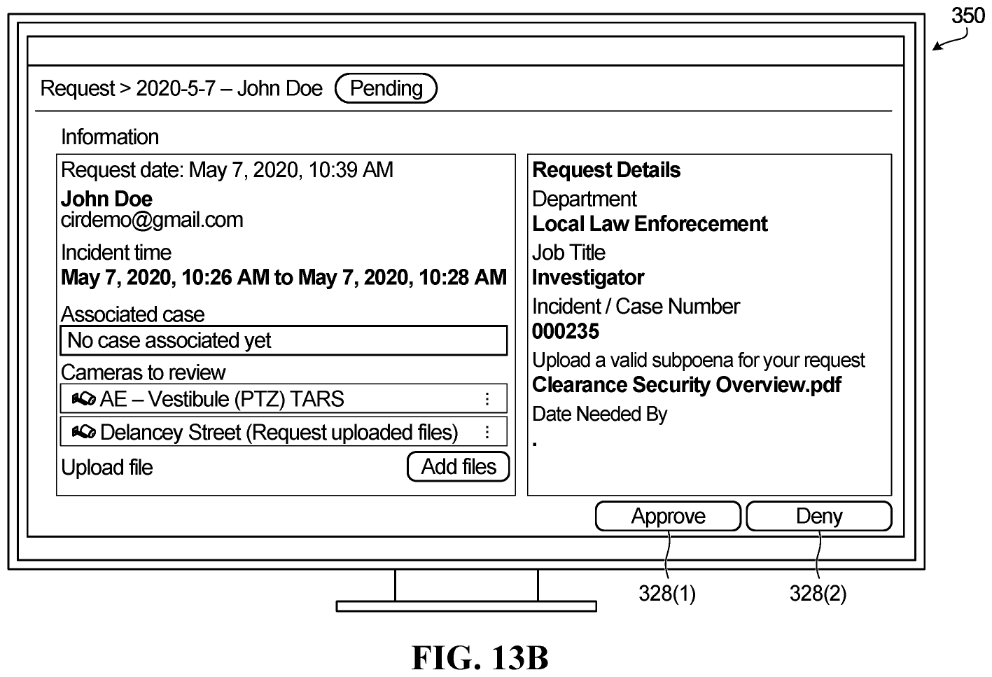

FIG. 13A shows is an embodiment of a non-limiting exemplary graphical user interface for generating a resource sharing request. As shown in FIG. 13A, the graphical user interface includes several fields 1301 for collecting one or more request parameters. The graphical user interface includes a user-selectable element 328(3) configured to allow a member to submit a resource sharing request (e.g., once the request parameters have been provided). The request may then be sent to the resource access module 1204 via the device interface module 1202. The request is received or otherwise rendered accessible via the device interface module 1202. Thus, the security server 104 includes an interface configured for receiving resource sharing requests. The request may be stored in the storage 208 of the security server 104 or is otherwise accessible at the security server 104.

Although the second tenant account 106(2) is designated a partner account of the first tenant account 106(1), the second tenant account 106(2) does not automatically have access to the data of the first tenant account 106(1). For instance, the second tenant account 106(2) does not automatically gain access to the to the data associated with the resources of the first tenant account 106(1).

The request to access a resource of the first tenant account 106(1) by the second tenant account 106(2) may be denied even if the second tenant account 106(2) is designated a partner account of the first tenant account 106(1). Thus, access by the second tenant account 106(2) to a resource of the first tenant account 106(1) is conditional on the approval of the request by the first tenant account 106(1).

By being designated the first tenant account 106(1), the second tenant account 106(2) may request access to a resource of the first tenant account 106(1) without being invited to access the resource by the first tenant account 106(1). For instance, the second tenant account 106(2) does not have to wait until the first tenant account 106(1) creates a case and invites the second tenant account 106(2) to request access to a resource on the basis of a case.

The request must be approved in order for the police department PD to access the resource of the transit authority TA. The request may be approved upon review of the request by a member of the transit authority TA. In this example, the member of the transit authority TA has a user account 114(2) associated with the tenant account 106(1) of the transit authority TA. In this embodiment, the user account 114(2) is configured to include privileges authorizing the user account 114(2) to review and approve such requests. For instance, the user account 114(2) may be configured to have administrator privileges.

In some embodiments, the member of the transit authority TA may be notified that a new request is available to be reviewed. A notification may be transmitted to the user account 114(2) to notify the member of the transit authority TA. For instance, the resource access module 1204 may be configured to send a notification to the computing device 350 associated with the transit authority TA via the device interface 1202. In some embodiments, the alert can include an electronic notification in the form of a text message, an email, a push-notification and the like. A suitable interface may be configured for approval of the request at the computing device 350. The way a request is approved can vary. In one implementation, a notification generated and sent by the resource access module 1204 can include or be associated with a mechanism for receiving feedback to provide a status of the request (e.g., approved, denied, conditionally approved, conditionally denied, under review, etc.). For example, the notification can be a GUI element displayed at the computing device 350 associated with the transit authority TA that can be configured to include a prompt directing the user to respond to the notification (e.g., email, push notification, text message) to provide the status of the request.

Reference is now made to FIG. 13B, illustrating an embodiment of a non-limiting exemplary graphical user interface for viewing a resource sharing request.

In this example, the graphical user interface includes information regarding a resource sharing request. The information regarding a resource sharing request may include information regarding the member initiating the request, the status of the request (e.g., denied, approved, pending, conditionally approved, conditionally denied, etc.), details regarding the incident being investigated, etc. The information may comprise any suitable information regarding the request. The graphical user interface also includes user-selectable elements 328(1), 328(2) configured to allow a member to approve or deny a resource sharing request received from an authorized partner.

The request is approved based on approval criteria established by the first tenant entity. In this example, the request is approved based on approval criteria established by the transit authority TA.

In some cases, the approval criteria established by one entity may differ from the approval criteria established by another entity with respect to requests for sharing video data. For instance, the approval criteria established by the police department PD may differ from the approval criteria established by the transit authority. In this embodiment, the approval criteria established the police department PD for approving requests for sharing video data does not override the approval criteria of the transit authority TA for approving requests for sharing video data.

In some cases, the request may require approval from more than one user account 114 associated with the tenant account 106(2) of the transit authority TA.

It should be noted that the video data associated with the resource is inaccessible to the second tenant account 106(2) until approval of the request.

In some embodiments, the security server 104 determines whether the request is approved. Upon approval of the request, the video data may be shared with the second tenant account 106(2). Thus, upon approval, the video data may be made accessible to the second tenant account 106(2).

In one example, once a member selects a user-selectable element 328(1), 328(2) to approve or deny a request, information indicative of the response is sent to the resource access module 1204 via the device interface module 1202. Thus, the request is processed (e.g., approved, denied, etc.) via the device interface module 1202. Thus, the security server 104 includes an interface configured for processing resource sharing requests.

Sharing the video data may entail automatically storing the video data associated with the resource in a tenant database 212 in association with the second tenant account 106(2). The resource access module 1204 may thus be configured for the video data associated with the resource in a tenant database 212 in association with the second tenant account 106(2) and is thus communicatively coupled with the tenant database 212. For instance, the video data may be stored in the evidence database 216, the media archive 228, and/or another suitable database. Moreover, information related to the video data may be stored in one or more of the records database 214, the audit trail database 224, the resource database 226, etc.

The video data associated with the resource may not be available for storing at the time of approval of the request. For instance, the request may be for access to video data associated with a bus passing in a geographical area of interest at a particular time frame. However, the video data for this bus may not yet be stored in the security server 104 at the time of the request. For instance, there may be delays in uploading the video data due to constraints such as network connectivity constraints making it possible to upload video data only when the vehicle is static for a period of time.

Thus, a member of the police department PD may request access to a resource without having seen the video data associated with this resource.

The video data associated with the resource may be stored automatically in a media archive 228 or another one of the tenant databases 212 in association with the second tenant account 106(2) upon determining that the video data is available for storing.

For instance, a situation may arise such that the video data associated with the resource may not be available for storing at the time of approval of the request. For instance, the video data associated with the resource may not yet be stored in the media archive 228 of the first tenant 106(1) at the time of the request. The video data may be imported into the media archive 228 after the request has been made and approved. In such a case, the video data may then automatically be pulled into the digital evidence system in association with the first tenant account 106(1) and the second tenant account 106(2). For instance, the video data may be pulled into one or more of the tenant databases 212 of the second tenant account 106(2) and in one or more of the tenant databases 212 of the first tenant account 106(1) other than the media archive 228.

The video data may be pulled into the tenant databases 212 via a suitable application program interface (API). The API may interface is provided for interfacing between the media archive 228 of the video management system and one or more of the other tenant databases 212 of the digital evidence management system to pull the video data from the media archive 228 into the tenant databases 212 of the digital evidence management system.

Based on the request being received and/or approved, a case may be created. As such, receiving and/or approving the request may include creating a record in the record database 214 associated with first and/or the second tenant accounts 106(1), 106(2). The resource access module 1204 may be configured to create a record in the record database 214 upon receiving information indicative of the request having been approved.

It should also be understood that the request to access the resource of the first tenant account 106(1) may be denied. For instance, it may be determined that the transit authority TA does not wish for the police department PD to have access to that particular video data at the time of the request due to privacy concerns.

If the request is denied, the video data is not made accessible to the second tenant account 106(2). Thus, if the request is denied, the video data associated with the resource is not stored in the tenant database 212 in association with the second tenant account 106(2). That is, the video data may be precluded or prevented from being stored in the tenant database 212 in association with the second tenant account 106(2).

Even in the event that the request be denied, the police department PD remains an authorized partner of the transit authority TA. Thus, should the request be denied, the second tenant account 106(2) remains a partner account of the first tenant account 106(1).

In some embodiments, a portion of the request may be approved, and a portion of the request may be denied. For instance, the request may include a first request for access to a first resource and a second request for access to a second resource. Based on the first request being approved, the video data associated with the first resource is automatically stored in the tenant database 212 in association with the second tenant account 106(2). Based on the first request being denied, the video data associated the second resource is not stored in the tenant database 212 in association with the second tenant account 106(2). That is the video data is precluded from being stored in association with the second tenant account 106(2).

The security server 104 may be configured to maintain an indication of all requests received from the second tenant 106(2) in relation to the first tenant 106(1). The security server 104 may store this information in storage 208. For instance, this information may be stored in the account database 232 or any other database.

The security server 104 may be configured to store audit trail information related to access of the resource by the police department PD.

The audit trail data includes audit trail data related to the first user account 106(1) and the audit trail data second user account 106(2).

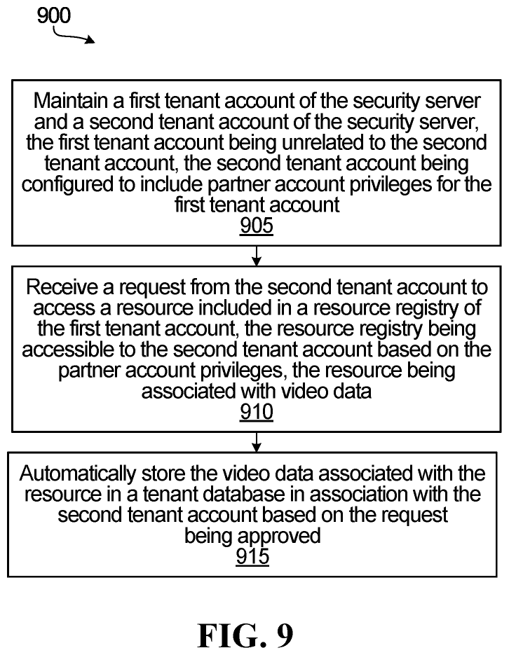

With reference therefore to FIG. 9, it will be appreciated that there has been provided a method 900 for sharing video data across tenants of a multi-tenant security system in accordance with example embodiments.

At step 905, the method comprises maintaining a first tenant account of the security server and a second tenant account of the security server, the first tenant account being unrelated to the second tenant account, the second tenant account being configured to include partner account privileges for the first tenant account.

At step 910, the method comprises accessing a request from the second tenant account to access a resource included in a resource registry of the first tenant account, the resource registry being accessible to the second tenant account based on the partner account privileges, the resource being associated with video data.

At step 915, the method comprises automatically storing the video data associated with the resource in a tenant database in association with the second tenant account based on the request being approved.

### Management of Resource Sharing Requests by an Image Processing Device

A request by the second tenant account 106(2) to access a resource included in the resource registry 120 of the first tenant account 106(1) may be initiated and processed in any other suitable fashion.

For instance, the request may be processed by an image processing device (camera 102) rather than by the security server 104.

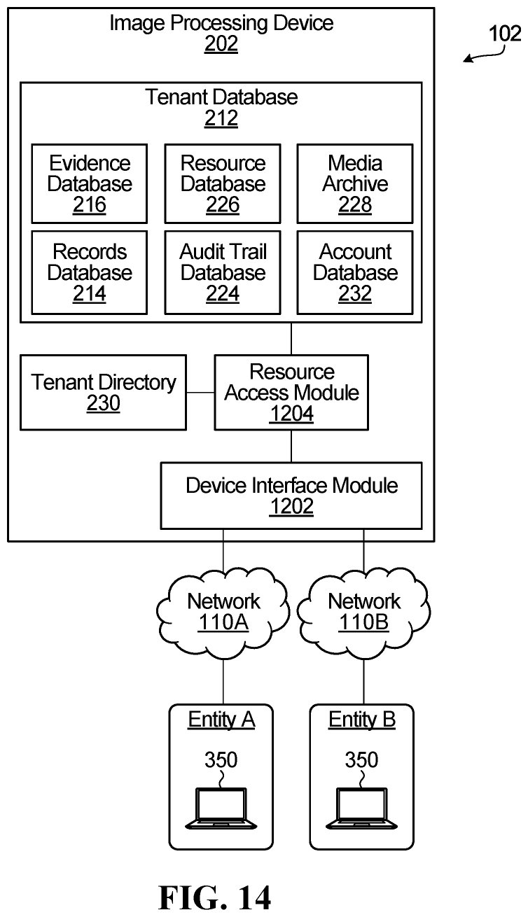

In some examples, execution of the instructions stored in the memory 311 results in the processing system 300 of an image processing device 102 implementing a resource access module and a device interface module. FIG. 14 is a functional representation of the imaging processing device 102, including the device interface module 1202, the resource access module 1204, the set of tenant databases 212 and the tenant directory 230, as previously described with respect to the server 104. The set of tenant databases 212 and the tenant directory 230 are communicatively coupled to the resource access module 1204.

The resource access module 1204 is configured to carry out a resource sharing method 1000. The resource sharing method 1000 is implemented to manage resource sharing requests from a first one of the tenant accounts 106(1)-106(n) that is a partner account to a second one of the tenant accounts 106(1)-106(n).

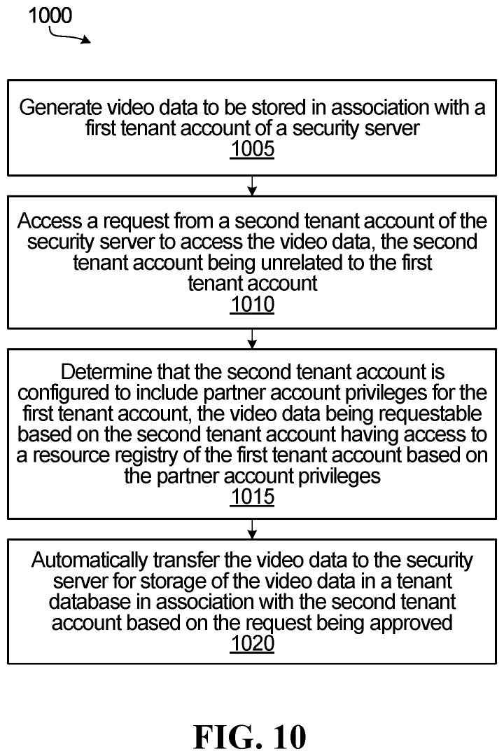

FIG. 10 illustrates an example flowchart representing the method 1000 for sharing video data across tenants of a multi-tenant security system for execution by an image processing device 102.

The method comprises:

At step 1005, the method comprises generating video data to be stored in association with a first tenant account of a security server.

At step 1010, the method comprises accessing a request from a second tenant account of the security server to access the video data, the second tenant account being unrelated to the first tenant account.

At step 1015, the method comprises determining that the second tenant account is configured to include partner account privileges for the first tenant account, the video data being requestable based on the second tenant account having access to a resource registry of the first tenant account based on the partner account privileges.

At step 1020, the method comprises automatically transferring the video data to the security server for storage of the video data in a tenant database in association with the second tenant account based on the request being approved.

Thus, the method may be considered “serverless” to the extent that processing the request is done by the image processing device 102 and not the server 104. That is the request is processed by the processing system 200 of the image processing device 102. In such cases, the processing system 200 of the image processing device 102 may run the digital evidence management software.

The video data may be stored in the storage 408 of the image processing device 102. The video data may be stored until such time as it is determined that the video data may be uploaded to the security server 104.

This may be managed, for instance, by an API which is compatible with the device, and which is implemented to manage such requests.

Such a method may be implemented in geographical areas with low network connectivity such as geographical areas which are underground (e.g., an underground train station, an underground subway station, in a tunnel, etc.). In such cases, a request may be “queued up” ahead of the video data being available for upload at the server 104. In such embodiments, small increments of video data may be transferred by the image processing device 102 to the server 104 until such time as an entire video data file is transferred to the server 104.

### Alternate Architecture

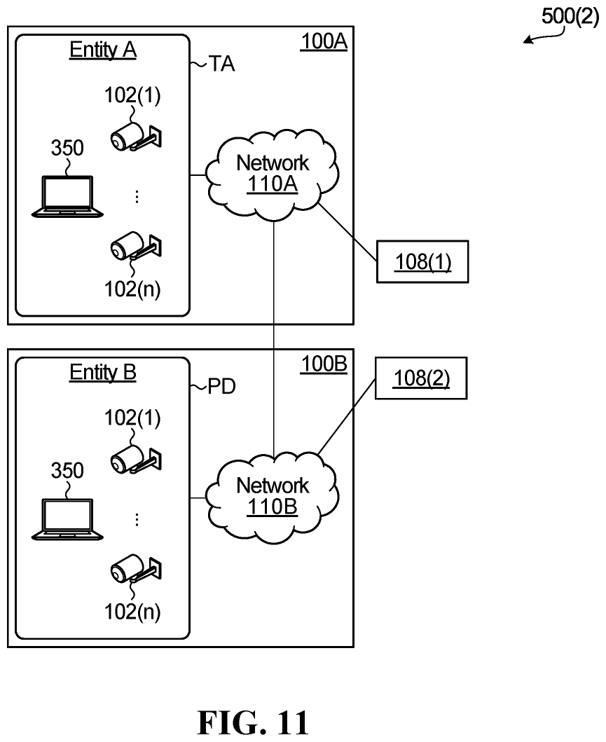

FIG. 11 illustrates an alternative multi-tenant security system 500(2) where a plurality of separate physical servers 108(1)-108(n) (generically referred to as physical server 108) communicate with each other to implement the methods described herein. The alternative security system 500(2) is similar to the security system 500(1) except that the security server 104 of FIG. 1 has a cloud-based server infrastructure to provide services to different respective tenant accounts 106(1)-106(n), whereas each physical server 108 is configured with hardware comprising physical components arranged in a specific configuration to provide services to a respective tenant account 106. The plurality of physical servers 108 could be on-premises servers, different servers at different respective data centers, or three different cloud servers. Communications among the physical servers 108(1)-108(n) with respect to each other may be established by any suitable communication links over the network 110A, 110B, which may incorporate wired communication links or wireless communication links. The wireless communication links may be established in a WLAN, a cellular network, or a wireless person area network (WPAN). The WPAN includes a short-range wireless communication, for example including Bluetooth® communication or near field communication (NFC). In other examples, one or more of the physical servers 108(1)-108(n) may establish a peer-to-peer (P2P) or distribute computing environment. Various protocols, such as Advanced peer-to-peer networking (APPN), BitTorrent, Direct Connect, FastTrack, and so on, may be applied by the P2P communication.

In some examples, the camera 102 is a device capable of capturing images and/or recording videos and communicating with the cloud-based server 104 or the physical server 108.

A user may connect to the physical digital evidence management server 108 with a desktop application to view the video feeds when the server is an on-premises server 108. Similarly, a user may connect to the cloud digital evidence management server 104 with a web application or web browser, for example, when the server is a cloud computing environment.

Thus, the security systems 500(1), 500(2) of FIGS. 1 and 11 provide suitable network environment to enable the camera 102 to send captured video data to a server or a cloud account via the network 110A, 110B.

The server 108 may additionally communicate with a computer or other user device over a physical link such as a data port (e.g., USB port), which can occur during server setup or diagnostics testing, for example.

A member of an entity may connect to the server 108 with a desktop application of the computing device 350 to access the digital evidence management services and the video management services provided by the server 108. A client application program may be stored in the storage of the computing device 350 that is associated with the security system 500(2), the client application program providing the user with an interface to interact with the security system 500(2).

In one embodiment, the security server 108 (e.g., 108(1), 108(2)) is configured for generating a graphical user interface displaying the resource registry 120 described above. In another embodiment, the computing device 350 is configured for generating a graphical user interface displaying the resource registry 120 described above.

In some embodiments, the connection between the security server 108 and the computing device 350 may be a wired connection.

The computer-readable storage medium referred to above can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, does not include transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from such computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer-readable program instructions for storage in the computer-readable storage medium within the respective computing/processing device.

The computer-readable program instructions for carrying out operations of the present disclosure may be assembler instructions, instruction-set-architecture (ISA) instructions, machine instructions, machine dependent instructions, microcode, Firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer-readable program instructions to personalize the electronic circuitry, in order to perform aspects of the present disclosure.

Aspects of the present disclosure are described herein with reference to flowchart/signal flow illustrations and/or block diagrams of methods, apparatus (systems), and computer program products according to various embodiments. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration and are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It should be appreciated that throughout the specification, discussions utilizing terms such as “processing”, “computing”, “calculating”, “determining”, “analyzing” or the like, can refer to the action and/or processes of a computer or computing system, or similar electronic computing device, that manipulate and/or transform data represented as physical, such as electronic, quantities into other data similarly represented as physical quantities.

Additionally, reference throughout this disclosure to “one embodiment,” “exemplary embodiment,” or “an embodiment” means that a particular feature, structure or characteristic described in connection with the embodiment is included in at least one embodiment of the present disclosure. Thus, appearances of the phrases “in one embodiment,” “in an exemplary embodiment,” or “in an embodiment” in various places throughout this specification are not necessarily all referring to the same embodiment, although this may be the case in some instances. Furthermore, the particular features, structures or characteristics may be combined in any suitable manner, as would be apparent to one of ordinary skill in the art from this disclosure, in one or more embodiments. Similarly it should be appreciated that, in the above description of example embodiments, various features are sometimes grouped together in a single embodiment, figure, or description thereof for the purpose of streamlining the disclosure and aiding in the understanding of one or more of the various aspects. This method of disclosure, however, is not to be interpreted as reflecting an intention more features are features are required than are expressly recited in each claim. Rather, as the following claims reflect, aspects may lie in less than all features of a single foregoing disclosed embodiment. Thus, the claims following the Detailed Description are hereby expressly incorporated into this Detailed Description, with each claim standing on its own as a separate embodiment. Furthermore, while some embodiments described herein include some but not other features included in other embodiments, combinations of features of different embodiments are meant to be within the scope of the disclosure, and form different embodiments, as would be understood by those in the art. For example, in the following claims, any of the claimed embodiments can be used in any combination.

As used herein, unless otherwise specified, the use of the ordinal adjectives “first”, “second”, “third”, etc., to describe a common object or step, merely indicate that different instances of like objects or steps are being referred to, and are not intended to imply that the objects or steps so described must be in a given sequence, either temporally, spatially, in ranking, or in any other manner.

It is noted that various individual features may be described only in one exemplary embodiment herein. The particular choice for description herein with regard to a single exemplary embodiment is not to be taken as a limitation that the particular feature is only applicable to the embodiment in which it is described. All features described herein may be equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

Also, when the phrase “at least one of A and B” is used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles and modes of operation of certain embodiments. However, these embodiments should not be considered limiting. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

1. A method for sharing video data across tenants of a multi-tenant security system, the method comprising:
a. maintaining a first tenant account of the security server and a second tenant account of the security server, the first tenant account being unrelated to the second tenant account, the second tenant account being configured to include partner account privileges for the first tenant account;
b. accessing a request from the second tenant account to access a resource included in a resource registry of the first tenant account, the resource registry being accessible to the second tenant account based on the partner account privileges, the resource being associated with video data; and
c. automatically storing the video data associated with the resource in a tenant database in association with the second tenant account based on the request being approved.

2. The method of claim 1, wherein the resource registry being accessible to the second tenant account comprises making accessible a list of resources to the second tenant account.

3. The method of claim 1, wherein the resource registry being accessible to the second tenant account comprises making accessible a digital map graphically identifying locations of resources in a geographical area.

4. The method of claim 1, wherein the resource registry indicates a location of a resource.

5. The method of claim 1, wherein a resource in the resource registry comprises a vehicle camera.

6. The method of claim 5, wherein the vehicle camera is identified by a transit identifier.

7. The method of claim 1, wherein the tenant database is a plurality of tenant databases.

8. The method of claim 1, wherein the video data associated with the resource is inaccessible to the second tenant account until approval of the request.

9. The method of claim 1, wherein the method further comprises processing the request at an interface of a computing apparatus of the system configured for processing the request, wherein processing comprises approving or denying the request.

10. The method of claim 1, wherein the request is a first request for access to a first resource and the request further comprises a second request for access to a second resource, wherein the method further comprises precluding the storing of the video data associated with the second resource in the tenant database in association with the second tenant account based on the second request being denied.

11. The method of claim 10, wherein the second tenant account retains partner account privileges for the first tenant account further to the request being denied.

12. The method of claim 1, wherein the request is approved based on approval criteria associated with the first tenant account.

13. The method of claim 12, wherein the approval criteria include receiving approval from one or more user accounts associated with the first tenant account, the one or more user accounts being authorized to approve the request.

14. The method of claim 1, wherein the method further comprises determining that the video data associated with the resource is not available for storing at the time of approval of the request, and automatically storing the video data associated with the resource in the tenant database in association with the second tenant account upon determining that it is available for storing.

15. The method of claim 1, wherein the method further comprises storing audit trail data associated with the video data.

16. The method of claim 15, wherein the audit trail data comprises audit trail data related to the first user account and audit trail data related to the second user account.

17. The method of claim 1, wherein the partner account privileges are bidirectional account privileges.

18. The method of claim 1, wherein the partner account privileges are unidirectional account privileges.

19. A security server, comprising:
a processor;
an interface;
a memory operatively coupled to the processor and comprising computer-readable instructions executable by the processor;
wherein execution of the computer-readable instructions by the processor causes the security server to carry out a method that comprises:
a. maintaining a first tenant account of the security server and a second tenant account of the security server, the first tenant account being unrelated to the second tenant account, the second tenant account being configured to include partner account privileges for the first tenant account;
b. accessing a request from the second tenant account to access a resource included in a resource registry of the first tenant account, the resource registry being accessible to the second tenant account based on the partner account privileges, the resource being associated with video data; and
c. automatically storing the video data associated with the resource in a tenant database in association with the second tenant account based on the request being approved.

20. A non-transitory computer-readable medium comprising computer-readable instructions which, when executed by a processor of a security server, cause the security server to carry out a method that comprises:
a. maintaining a first tenant account of the security server and a second tenant account of the security server, the first tenant account being unrelated to the second tenant account, the second tenant account being configured to include partner account privileges for the first tenant account;
b. accessing a request from the second tenant account to access a resource included in a resource registry of the first tenant account, the resource registry being accessible to the second tenant account based on the partner account privileges, the resource being associated with video data;
c. and
d. automatically storing the video data associated with the resource in a tenant database in association with the second tenant account based on the request being approved.

21. A method for execution by an image processing device, the method comprising:
a. generating video data to be stored in association with a first tenant account of a security server;
b. accessing a request from a second tenant account of the security server to access the video data, the second tenant account being unrelated to the first tenant account;
c. determining that the second tenant account is configured to include partner account privileges for the first tenant account, the video data being requestable based on the second tenant account having access to a resource registry of the first tenant account based on the partner account privileges; and
d. automatically transferring the video data to the security server for storage of the video data in a tenant database in association with the second tenant account based on the request being approved.

22. The method of claim 21, wherein said automatically transferring comprises incrementally transferring the video data to the security server.

23. A method for configuring a tenant account to access a resource registry of an unrelated tenant account, the method comprising:
a. maintaining a first tenant account and a second tenant account, the second tenant account being unrelated to the first tenant account;
b. maintaining a resource registry of the first tenant account, the resource registry being indicative of a set of one or more resources associated with the first tenant account; and
c. configuring the second tenant account to include tenant account privileges enabling the second tenant account to access the resource registry of the first tenant account; and
d. displaying the resource registry of the first tenant account at a computing device accessed by the second tenant account.

24. The method of claim 23, wherein the one or more resources associated with the first tenant account are associated with video data and wherein access to the video data by the second tenant account requires a request for access to the video data.
